(19) United States
(12) Patent Application Publication
(10) Pub. No.: US 2021/0119803 A1
(43) Pub. Date: Apr. 22, 2021

(54) SYSTEMS AND METHODS FOR INFORMATION MANAGEMENT

(71) Applicant: YUNDING NETWORK TECHNOLOGY (BEIJING) CO., LTD., Beijing (CN)

(72) Inventors: Guoliang LI, Beijing (CN); Lei WANG, Beijing (CN); Canjin GAO, Beijing (CN)

(73) Assignee: YUNDING NETWORK TECHNOLOGY (BEIJING) CO., LTD., Beijing (CN)

(21) Appl. No.: 17/137,281

(22) Filed: Dec. 29, 2020

Related U.S. Application Data
(63) Continuation of application No. PCT/CN2019/093933, filed on Jun. 29, 2019.

(30) Foreign Application Priority Data
Jun. 29, 2018 (CN) 201810694970.4
Jun. 29, 2018 (CN) 201810694984.6
Nov. 30, 2018 (CN) 201811453456.8

(51) Int. Cl. H04L 9/32; G06F 21/32; G06F 21/60; G06F 21/62

(52) U.S. Cl. CPC H04L 9/3231; G06F 21/6209; G06F 21/602; G06F 21/32

(57) ABSTRACT

A method and system for information management. The method may include: obtaining a feature file of a user from a control medium, the feature file of the user including feature information of the user; the feature information of the user being generated and sent to the control medium by a first terminal device; storing the feature file of the user; receiving a first request sent by the control medium for downloading the feature information of the user; and sending, in response to the first request, the feature information of the user to the control medium so as to enable the control medium to send the feature information of the user to a target device.

### CROSS REFERENCE TO RELATED APPLICATIONS

The present disclosure is a continuation of International Patent Application No. PCT/CN2019/093933 filed on Jun. 29, 2019, which claims priority of Chinese Patent Application No. 201810694984.6 filed on Jun. 29, 2018, Chinese Patent Application No. 201810694970.4, filed on Jun. 29, 2018, and Chinese Patent Application No. 201811453456.8, filed on Nov. 30, 2018, the contents of each of which are hereby incorporated by references.

### TECHNICAL FIELD

The present disclosure generally relates to the technical field of information processing, and specifically, to systems and methods for information management.

### BACKGROUND

At present, more and more terminal devices use fingerprint recognition technology to verify user identity, and the implementation process is: a terminal device generates and saves fingerprint feature information according to the fingerprint input multiple times by a certain user; when the terminal device needs to authenticate an operator, the operator's fingerprint is collected, and feature information of the collected fingerprint is compared with the pre-stored fingerprint feature information of the certain user to authenticate the operator. However, when the memory on the terminal device for storing the fingerprint feature information is damaged and replaced with a new one, since the originally stored fingerprint feature information has been lost, the user needs to re-input the fingerprint to regenerate the fingerprint feature information, which brings the user inconvenience.

In addition, for the current ordinary terminal devices, corresponding operations performed when sending control commands to these ordinary terminal devices are local operations performed on these devices. There is no problem related to intermediate status caused by untimeliness in operation of the control command. But for devices such as commercial smart devices (e.g., fingerprint electronic locks), in scenarios that fingerprints are remotely input and remotely operated (e.g., fingerprint electronic locks in hotels, long/short-rent apartments, public rental housing, etc.), when an administrator or a tenant sends a control command to the fingerprint electronic lock remotely (e.g., inputs a fingerprint and performs corresponding operations on the fingerprint, etc.), since the control command needs to be sent to the target electronic lock immediately via a Zigbee or Bluetooth network, the control command generates an intermediate status due to the limitation of the two communication modes, and the intermediate status is not displayed at a terminal device, so there may be a problem of a timely operation. The control command includes a control command for the remotely input fingerprint, such as a sending command, a freezing command, an unfreezing command, a valid period modification command or a deletion command, etc.

Therefore, it is desirable to provide systems and methods for information management to reduce the risk of easy loss of information stored locally on the terminal device and to reflect the processing status of the control command.

### SUMMARY

According to an aspect of the present disclosure, a method implemented on a machine including at least one processor and at least one storage device is provided. The method may include: obtaining a feature file of a user, the feature file of the user including feature information of the user; the feature information of the user being generated by a first terminal device; storing the feature file of the user; receiving a first request for obtaining the feature information of the user; and sending, in response to the first request, the feature information of the user to a target terminal device.

In some embodiments, the feature file of the user is encrypted with a first key corresponding to the first terminal device; the storing the feature file of the user includes: acquiring the first key corresponding to the first terminal device; decrypting, using the first key, the feature file of the user encrypted with the first key to obtain a decrypted feature file of the user and storing the decrypted feature file of the user.

In some embodiments, the storing the decrypted feature file of the user includes: verifying the decrypted feature file of the user; and in response to passing the verification, storing the decrypted feature file of the user.

In some embodiments, the storing the decrypted feature file of the user includes: encrypting the decrypted feature file of the user with a second key corresponding to the machine to obtain a feature file of the user encrypted with the second key; and storing the feature file of the user encrypted with the second key.

In some embodiments, the feature information of the user is encrypted with a first key corresponding to the first terminal device; the feature file of the user further includes an identification of the user; the storing the feature file of the user includes: acquiring the first key corresponding to the first terminal device; decrypting, using the first key, the feature information of the user encrypted with the first key to obtain the decrypted feature file of the user including decrypted feature information of the user and the identification of the user; and storing the decrypted feature file of the user.

In some embodiments, the storing the decrypted feature file includes: verifying the decrypted feature information; in response to passing the verification, storing the decrypted feature file of the user.

In some embodiments, the storing the decrypted feature file of the user includes: encrypting, using a second key corresponding to the machine, the decrypted feature file of the user to obtain a feature file of the user encrypted with the second key; and storing the feature file of the user encrypted with the second key.

In some embodiments, the first request includes an identification of the target device and the identification of the user; the sending, in response to the first request, the feature information of the user to a target terminal device includes: retrieving, based on the identification of the user, the feature information of the user from feature information of a plurality of users; acquiring, based on the identification of the target device, a third key corresponding to the target device; encrypting the feature information of the user with the third key; and sending the feature information encrypted with the third key to the target device.

In some embodiments, the machine is a server; the obtaining a feature file of a user includes: obtaining the feature file of a user from a control medium; the feature information of the user is sent to the control medium by the first terminal device; the sending, in response to the first request, the feature information of the user to a target user includes: sending, in response to the first request, the feature information of the user to the control medium so as to enable the control medium to send the feature information of the user to the target terminal device.

In some embodiments, the method further includes: receiving a second request for controlling the target device; generating a control command in response to the second request; assigning the control command a preliminary status; sending the control command to the target device to control the target device; receiving a result of the target device performing the control command; and updating, based on the result, the preliminary status of the control command.

According to another aspect of the present disclosure, a system is provided.

The system includes: at least one storage medium storing a set of instructions; at least one processor in communication with the at least one storage medium, wherein when executing the set of instructions, the at least one processor is directed to cause the system to: obtain a feature file of a user, the feature file of the user including feature information of the user; the feature information of the user being generated by a first terminal device; store the feature file of the user; receive a first request for obtaining the feature information of the user; and send, in response to the first request, the feature information of the user to a target terminal device.

According to another aspect of the present disclosure, a non-transitory computer-readable medium is provided. The non-transitory computer-readable medium includes at least one set of instructions, wherein when executed by at least one processor of a computer device, the at least one set of instructions directs the at least one processor to: obtain a feature file of a user, the feature file of the user including feature information of the user; the feature information of the user being generated by a first terminal device; store the feature file of the user; receive a first request for obtaining the feature information of the user; and send, in response to the first request, the feature information of the user to a target terminal device.

According to another aspect of the present disclosure, another method implemented on a machine including at least one processor and at least one storage device is provided. The method includes: receiving a first feature file of a user from a first terminal device; the first feature file of the user including feature information of the user; sending a second feature file of the user to a server, so as to enable the server to store the second feature file of the user, the second feature file of the user including the feature information of the user; sending a request for obtaining the feature information of the user to the server; receiving the feature information of the user sent by the server in response to the request; and sending the feature information of the user received from the server to a target terminal device.

In some embodiments, the receiving a first feature file of a user from a first terminal device includes: receiving the first feature file of the user encrypted with a first key.

In some embodiments, the first feature file of the user further includes an identification of the user; and the second feature file of the user includes an identification of the first terminal device and the first feature file of the user encrypted with the first key; or the first feature file of the user does not include an identification of the user; the method further comprising: obtaining an identification of the user; and the second feature file of the user includes the identification of the first terminal device, the identification of the user, and the first feature file of the user encrypted with the first key.

In some embodiments, the request for obtaining the feature information of the user includes an identification of the target terminal device; the receiving the feature information of the user sent by the server in response to the request includes: receiving the feature information of the user encrypted with a second key sent by the server the feature information of the user encrypted with the second key being generated by the server encrypting, using the second key corresponding to an identification of the target terminal device, the feature information of the user.

In some embodiments, the receiving a first feature file of a user from a first terminal device includes: receiving at least one data packet from the first terminal device; the at least one data packet being generated by the first terminal device splitting the first feature file of the user.

In some embodiments, the first feature file of the user further includes first verification information corresponding to the feature information of the user, so as to enable the server to verify, based on the first verification information, the user feature information, and store the second feature file of the user in response to passing the verification.

In some embodiments, after sending a request to the server for obtaining the feature information of the user, the method further comprising: receiving second verification information corresponding the feature file of the user from the server; sending the second verification information to the target terminal device, so as to enable the target terminal device to verify, based on the second verification information, the received feature information of the user.

According to another aspect of the present disclosure, a system is provided.

The system includes: at least one storage medium storing a set of instructions; at least one processor in communication with the at least one storage medium, wherein when executing the set of instructions, the at least one processor is directed to cause the system to: receive a first feature file of a user from a first terminal device; the first feature file of the user including feature information of the user; send a second feature file of the user to a server, so as to enable the server to store the second feature file of the user, the second feature file of the user including the feature information of the user; send a request for obtaining the feature information of the user to the server; receive the feature information of the user sent by the server in response to the request; and send the feature information of the user received from the server to a target terminal device.

According to another aspect of the present disclosure, a non-transitory computer-readable medium is provided. The non-transitory computer-readable medium includes at least one set of instructions, wherein when executed by at least one processor of a computer device, the at least one set of instructions directs the at least one processor to: receive a first feature file of a user from a first terminal device; the first feature file of the user including feature information of the user; send a second feature file of the user to a server, so as to enable the server to store the second feature file of the user, the second feature file of the user including the feature information of the user; send a request for obtaining the feature information of the user to the server; receive the feature information of the user sent by the server in response to the request; and send the feature information of the user received from the server to a target terminal device.

According to another aspect of the present disclosure, another method implemented on a machine including at least one processor and at least one storage device is provided. The method includes: receiving a request for controlling a target device; generating, based on the request, a control task for controlling the target device, the control task including at least one control command; assigning the control task a preliminary status; sending the at least one control command to the target device to control the target device; receiving a result of the target device performing the at least one control command; and updating, based on the result, the preliminary status of the control task.

In some embodiments, the request for controlling the target device is a request for sending data to the target device, the method includes: acquiring data to be sent; generating, based on the request, a sending task, the sending task including at least one sending command; assigning the sending task a status as to be sent; sending the data to be sent and the at least one sending command to the target device; receiving a result of the target device performing the at least one sending command; and updating, based on the result, the status of the sending task as sent.

In some embodiments, the request for controlling the target device is a request for processing data in the target device, the method includes: generating, based on the request, a processing task, the processing task including at least one processing command; assigning the processing task a status as undone; sending the at least one processing command to the target device; receiving a result of the target device performing the at least one processing command; and updating, based on the result, the status of the processing task as done.

In some embodiments, the request for controlling the target device is a request for sending data to the target device, the method includes: acquiring data to be sent; generating, based on the request, a sending task, the sending task including at least one sending command; assigning the sending task a status as to be sent; sending the data to be sent and the at least one sending command to the target device; receiving a result of the target device performing the at least one sending command; and updating, based on the result, the status of the sending task as sent.

In some embodiments, the request for controlling the target device is a request for processing data in the target device, the method includes: generating, based on the request, a processing task, the processing task including at least one processing command; assigning the processing task a status as undone; sending the at least one processing command to the target device; receiving a result of the target device performing the at least one processing command; and updating, based on the result, the status of the processing task as done.

In some embodiments, the request is for controlling code information and/or fingerprint information.

According to another aspect of the present disclosure, another system is provided. The system includes: at least one storage medium storing a set of instructions; at least one processor in communication with the at least one storage medium, wherein when executing the set of instructions, the at least one processor is directed to cause the system to: receive a request for controlling a target device; generate, based on the request, a control task for controlling the target device, the control task including at least one control command; assign the control task a preliminary status; send the at least one control command to the target device to control the target device; receive a result of the target device performing the at least one control command; and update, based on the result, the preliminary status of the control task.

According to another aspect of the present disclosure, another non-transitory computer-readable medium is provided. The non-transitory computer-readable medium includes at least one set of instructions, wherein when executed by at least one processor of a computer device, the at least one set of instructions directs the at least one processor to: receive a request for controlling a target device; generate, based on the request, a control task for controlling the target device, the control task including at least one control command; assign the control task a preliminary status; send the at least one control command to the target device to control the target device; receive a result of the target device performing the at least one control command; and update, based on the result, the preliminary status of the control task.

### BRIEF DESCRIPTION OF THE DRAWINGS

The present disclosure is further described in terms of exemplary embodiments.

These exemplary embodiments are described in detail with reference to the drawings.

The drawings are not to scale. These embodiments are non-limiting exemplary embodiments, in which like reference numerals represent similar structures throughout the several views of the drawings, and wherein:

FIG. 1 is an application scenario diagram illustrating an information management system according to some embodiments of the present disclosure;

FIG. 2 is a flowchart illustrating an exemplary process for information management according to some embodiments of the present disclosure;

FIG. 3 is a block diagram illustrating an exemplary server according to some embodiments of the present disclosure;

FIG. 4 is a flowchart illustrating an exemplary process for an information processing method according to some embodiments of the present disclosure;

FIG. 5 is a flowchart illustrating an exemplary process for an information processing method according to some embodiments of the present disclosure;

FIG. 6 is a flowchart illustrating an exemplary process for storing a received fingerprint feature file by the server according to some embodiments of the present disclosure;

FIG. 7 is a flowchart illustrating an exemplary process for storing a received fingerprint feature file by the server according to some embodiments of the present disclosure;

FIG. 8 is a flowchart illustrating an exemplary process for storing a fingerprint feature file in the plaintext form obtained by decryption according to some embodiments of the present disclosure;

FIG. 9 is a flowchart illustrating an exemplary process for storing a fingerprint feature file by the server according to some embodiments of the present disclosure;

FIG. 10 is a flowchart illustrating an exemplary process for transmitting fingerprint feature information to the control medium according to some embodiments of the present disclosure;

FIG. 11 is a flowchart illustrating an exemplary process for an information processing method according to some embodiments of the present disclosure;

FIG. 12 is a flowchart illustrating an exemplary process for an information processing method according to some embodiments of the present disclosure;

FIG. 13 is a block diagram illustrating an exemplary server according to some embodiments of the present disclosure;

FIG. 14 is a flowchart illustrating an exemplary process for an information processing method according to some embodiments of the present disclosure;

FIG. 15 is a flowchart illustrating an exemplary process for processing information by the control medium according to some embodiments of the present disclosure;

FIG. 16 is a flowchart illustrating an exemplary process for processing information by the control medium according to some embodiments of the present disclosure;

FIG. 17 is a flowchart illustrating an exemplary process for processing information by the control medium according to some embodiments of the present disclosure;

FIG. 18 is a block diagram illustrating an exemplary control medium for processing information according to some embodiments of the present disclosure;

FIG. 19 is a flowchart illustrating an exemplary process for controlling an electronic lock according to some embodiments of the present disclosure;

FIG. 20 is a flowchart illustrating an exemplary process for controlling an electronic lock according to some embodiments of the present disclosure;

FIG. 21 is a flowchart illustrating an exemplary process of a control method when a request for the electronic lock is a sending request according to some embodiments of the present disclosure;

FIG. 22 is a flowchart illustrating an exemplary process of a control method when a control request for an electronic lock is a freezing request, an unfreezing request, a valid period modification request or a deletion request, according to some embodiments of the present disclosure;

FIG. 23 is a flowchart illustrating an exemplary process of an electronic lock control method according to some embodiments of the present disclosure;

FIG. 24 is a flowchart illustrating an exemplary process of an electronic lock control method according to some embodiments of the present disclosure;

FIG. 25 is a schematic diagram illustrating an exemplary electronic lock control device according to some embodiments of the present disclosure;

FIG. 26 is a schematic diagram illustrating an exemplary electronic lock control device according to some embodiments of the present disclosure;

FIG. 27 is a schematic diagram illustrating an exemplary electronic lock control device according to some embodiments of the present disclosure; and

FIG. 28 is a schematic diagram illustrating an exemplary electronic lock control system according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included of connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The following description is provided with reference to an information processing technique related to locking device. This is not intended to limit the scope the present disclosure. For persons having ordinary skills in the art, a certain amount of variations, changes, and/or modifications may be deducted under the guidance of the present disclosure. Those variations, changes, and/or modifications do not depart from the scope of the present disclosure.

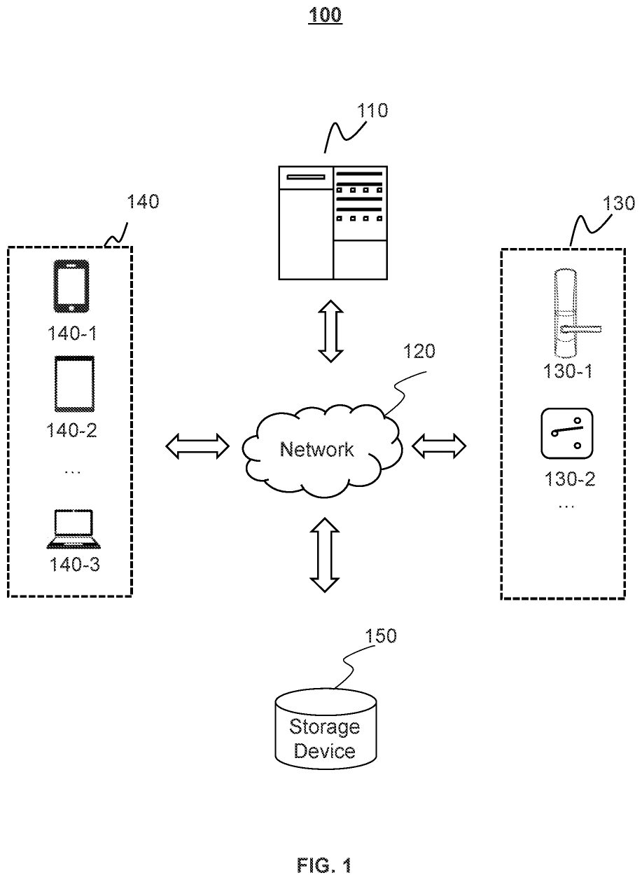

FIG. 1 is an application scenario diagram illustrating an information management system according to some embodiments of the present disclosure.

The information management system 100 may be used for scenarios involving authentication. In some embodiments, the information management system 100 may be used in a scenario involving a lock. For example, the information management system 100 may be used to manage locks for a home, a hotel, a long/short-rent apartment, a rental item, a shared item, etc. It should be noted that although the following describes a door lock as an example, the technical solution of the present disclosure is not limited to the door lock, but may also be used for any other scenario involving a lock or requiring authentication of the identity information before use allowance. As shown in FIG. 1, the information management system 100 may include a server 110, a network 120, a smart device 130, a user terminal 140, and a storage device 150.

The server 110 may process information and/or data related to authentication to perform one or more functions described in the present disclosure. For example, the server 110 may receive and store user feature information for authentication, and may also transmit the user feature information to a target device (e.g., the smart device 130) so that the target device may authenticate an operator locally. As another example, after receiving a control request of the user for a target device, the server 110 may generate a control command and send it to the target device for execution. In this process, the server 110 may also label a status of the control command, for example, the control command may be labeled as undone before being executed, and be labeled as done after being executed.

In some embodiments, after the authentication is successful, the server 110 may further detect whether an access suspension function of the target device is turned on. As used herein, an access suspension function of a lock refers a function that prohibits a user from unlocking the lock through one or more authentication mechanisms. In some embodiments, the access suspension function of a lock may be activated or deactivated remotely via, e.g., an APP or a browser implemented on a mobile device, a computer, etc., that is operably connected to the lock via a network. An access suspension function achieved remotely may be referred to as an electronic access suspension function. As used herein, “operably connected” indicates that two or more components (e.g., devices, units, modules, etc.) are connected in any suitable manner for operation and/or communication, including wired, wirelessly, or some combination thereof.

The server 110 may control the target device based on a status of the access suspension function (also referred to as an access suspension status) of the target device. In some embodiments, when the access suspension function (e.g., electronic access suspension function) of the target device is turned on, authentication based on the user feature information including biometric information (e.g., biometric information such as finger print, voice print, facial recognition, etc.), password, motion (e.g., a gesture of the user), etc., may be disabled. For example, the target device may be a door lock. When the door lock is in the access suspension status (i.e., the access suspension function being on), the server 110 may not send a control signal to unlock the door lock. When the access suspension function (e.g., the electronic access suspension function) is off, the server 110 may send a control signal to unlock the door lock. As another example, the target device may be a mobile device (e.g., a mobile phone) using an authentication option of a fingerprint and/or a password. Unless the access suspension function on the mobile device is off, the mobile device cannot be unlocked based on a fingerprint or a password collected by the mobile device. In some embodiments, when the access suspension function of the target device is turned on, authentication based on an electronic key, such as a Bluetooth key, a radio frequency identification card (RFID), etc., may also be disabled. In some embodiments, the access suspension status of the target device may be controlled by the user terminal 140 via the network 120. For example, an administrator of the target device may turn on or off the access suspension function (e.g., the electronic access suspension function) of the target device via the user terminal 140 (e.g., an application (APP) installed in the user terminal 140). As another example, the administrator may set a time period (e.g., from 8:00 am to 20:00 pm) during which the access suspension function may be automatically turned on, and beyond which the access suspension function may be automatically turned off. As a further example, when the access suspension function is on, an administrator can override the access suspension function and unlock the target device using, e.g., an administrator password, a master password, etc. In some embodiments, when the target device is a door lock, the access suspension status of the door lock may further be controlled by a user from inside the room where the door lock is used. For example, when the user in the room where the door lock is used unlocks the door lock from inside the room, the access suspension function may be automatically turned off.

Accordingly, by detecting the access suspension function of the target device, the safety of the target device may be improved, thereby improving user experience. For example, the administrator of the target device, by turning on the access suspension function of the target device, may prohibit others (e.g., hackers) from unlocking the target device during a specific time period. As another example, the administrator, by turning on the access suspension function of the target device, may prohibit a user from unlocking the target device even if the user is successfully authenticated using user feature information.

In some embodiments, the server 110 may be a single server or a server group. The server group may be centralized or distributed (e.g., the server 110 may be a distributed system). In some embodiments, the server 110 may be local or remote. For example, the server 110 may access the smart device 130 and/or the user terminal 140 via the network 120. As another example, the server 110 may be directly connected to the user terminal 140 and/or the smart device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device. In some embodiments, the server 110 may be implemented on a mobile device.

The network 120 may facilitate exchange of information and/or data. The one or more components (e.g., the server 110, the smart device 130, the user terminal 140, and the storage device 150) of the information management system 100 may transmit information and/or data to other component(s) of the information management system 100 via the network 120. For example, the user terminal 140 may transmit user feature information to the server 110 via the network 120, so that the user feature information may be stored in the server 110, reducing the risk of easy loss of local storage. In some embodiments, the network 120 may be any type of wired or wireless network, or a combination thereof. For example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a general packet radio network (GPRS), a mobile telephone network, a Bluetooth network, a ZigBee network, a near field communication (NFC) network, a narrowband Internet of things (NB-IoT/LoRa), or the like, or any combination thereof. In some embodiments, the network 120 may include one or more network access points. For example, the network 120 may include wired or wireless network access points, such as base stations and/or Internet exchange points, through which one or more components of the information management system 100 may be connected to the network 120 to exchange data and/or information.

The smart device 130 may be a device that requires an authentication before being used, thereby ensuring that only an authorized user can use it, and avoiding the use of unauthorized persons. In some embodiments, the smart device 130 may include, but not limited to, a door lock, an electrical switch, a television, an air conditioner, etc. The smart device 130 may receive a command from the server 110 and/or the user terminal 140 and execute the command. For example, a door lock may receive a command from the server 110. The door lock may be locked or unlocked based on the command. In some embodiments, the smart device 130 may feedback its working status to the server 110. For example, the door lock may feed back the status of the door lock being locked or unlocked to the server 110. In some embodiments, the smart device 130 may also collect user feature information and transmit it to the server 110 to store the collected information in the cloud.

The user may access the information management system 100 through the user terminal 140. In some embodiments, the user terminal 140 may be a terminal used by an operator having an authorization to operate the smart device 130. For example, the authorized operator may input his/her feature information, such as biometric information, including but not limited to fingerprint information, iris information, palm vein information, facial information, sound information, etc. through the user terminal 140. In some embodiments, the user terminal 140 may be a terminal used by an administrator managing the smart device 130. For example, the administrator may be a hotel receptionist staff, a long/short-rent apartment management center staff, etc. The administrator may manage information of the authorized user through the user terminal 140. For example, the management may include but not limited to, sending the user feature information stored in the server 110 to the smart device 130, deleting, modifying, and freezing the information of the authorized user, etc. As another example, the administrator may set an access suspension status (e.g., an electronic access suspension status) of the smart device 130 via the user device 140. For instance, when the smart device 130 is in the access suspension status, the authorized operator may be unable to operate the smart device 130 using his/or her feature information. In such cases, the authorized operator may operate the smart device 130 by inputting a predetermined code preset by the administrator. In some embodiments, the user terminal 140 may include but not limited to a desktop computer, a laptop computer, a smartphone, a personal digital assistant (PDAs), a tablet computer, a handheld game player, smart glasses, a smart watch, a wearable device, a virtual display device, a display enhancement device, or the like, or any combination thereof.

The storage device 150 may store data and/or instructions. For example, the storage device 150 may store user feature file for authentication. In some embodiments, the storage device 150 may store data and/or instructions that the server 110 may execute or use to perform exemplary methods described in the present disclosure. In some embodiments, the storage device 150 may include a mass storage device, a removable memory, a volatile read/write memory, a read only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. It should be noted that, in some embodiments, the storage device 150 may be integrated inside the server 110, the smart device 130, and/or the user terminal 140.

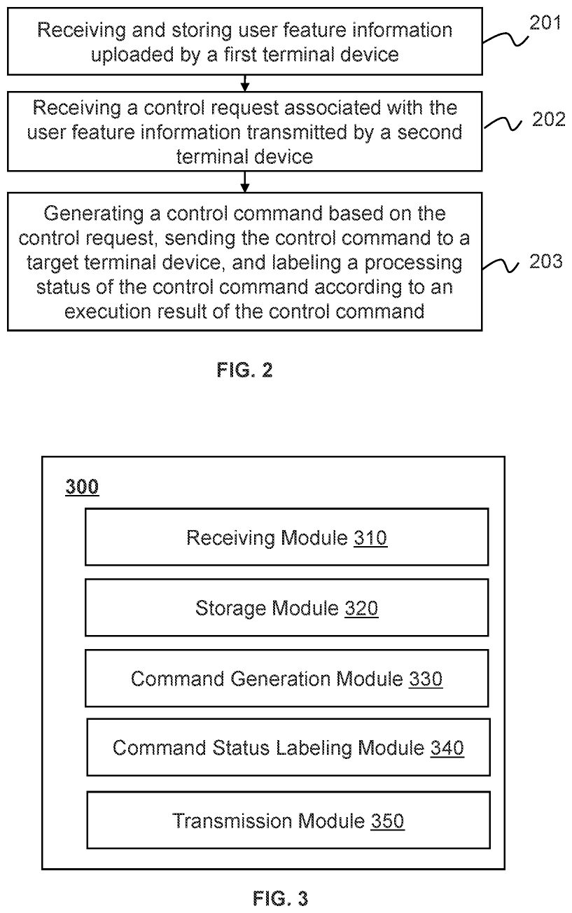

FIG. 2 is a flowchart illustrating an exemplary process for information management according to some embodiments of the present disclosure. The process may be implemented by the server 300 illustrated in FIG. 3. In some embodiments, the process illustrated in FIG. 2 may be implemented in the information management system 100 illustrated in FIG. 1 (e.g., by the server 110). For example, the process illustrated in FIG. 2 may be stored in a storage device (e.g., the storage device 150, a ROM, a RAM) in the form of instructions, and invoked and/or executed by one or more processors of the server 110.

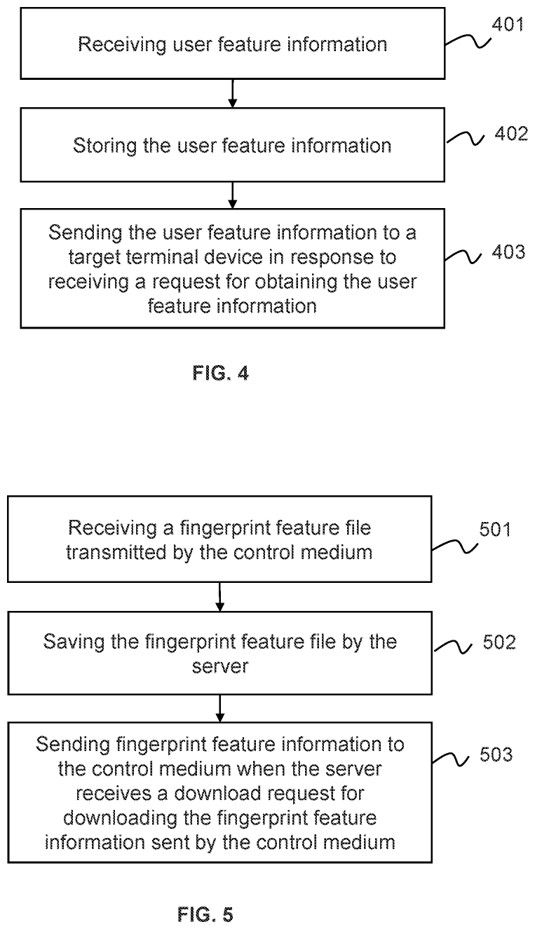

In 201, the server 110 may receive and store user feature information transmitted by a first terminal device. The first terminal device may acquire the user feature information and transmit the user feature information to the server for storage, which reduces the risk of information loss caused by local storage on the first terminal device. In some embodiments, the first terminal device may be a smart device (e.g., the smart device 130), including but not limited to a door lock, an electrical switch, a television, an air conditioner, etc. The user may input the user feature information to the smart device. In some embodiments, the first terminal device may be a user terminal (e.g., the user terminal 140) which may be a terminal used by an authorized user, or may be a terminal used by an administrator. The first terminal device may directly transmit the collected user feature information to the server 110. Alternatively, the first terminal device may firstly transmit the collected user feature information to a control medium, and then the user feature information may be transmitted to the server 110 by the control medium. The user feature information may be biometric information of the user, including but not limited to, fingerprint information, irs information, palm vein information, facial information, sound information, etc. In some embodiments, the user feature information may include non-biological information of the user, such as a password, motion information (e.g., a gesture of the user), etc. In some embodiments, the user feature information may further include a predetermined code set by the administrator of the first terminal device. An unauthorized user may gain access to the first terminal device (e.g., access to operate the first terminal device) by inputting the predetermined code. In some embodiments, in addition to the user feature information, the first terminal device may also acquire and transmit an identification of the user corresponding to the user feature information. Alternatively, the identification of the user may be acquired by the control medium, and then may be transmitted to the server 110 by the control medium. In some embodiments, the first terminal device may encrypt the user feature information and transmit the encrypted user feature information. After receiving the encrypted user feature information, the server 110 may decrypt the encrypted user information and store the decrypted user feature information. More descriptions about the server receiving the user feature information and/or the first terminal device transmitting the user feature information may be found elsewhere in the present disclosure. See, for example, FIGS. 4 to 18 and the descriptions thereof.

In 202, the server 110 may receive a control request associated with the user feature information transmitted by a second terminal device. An operator may initiate the control request through the second terminal device, and the second terminal device may transmit the control request to the server 110. The control request may be a request to control the user feature information. For example, the control request may be a request for sending, freezing, or unfreezing the user feature information, or modifying the period of validity of the user feature information, etc. In some embodiments, the second terminal device may be the smart device 130, and the operator may directly operate on the smart device 130 to initiate a control request. Alternatively, the second terminal device may be the user terminal 140, and the operator may initiate the control request via the user terminal 140. In some embodiments, the second terminal device and the first terminal device may be the same device, or different devices.

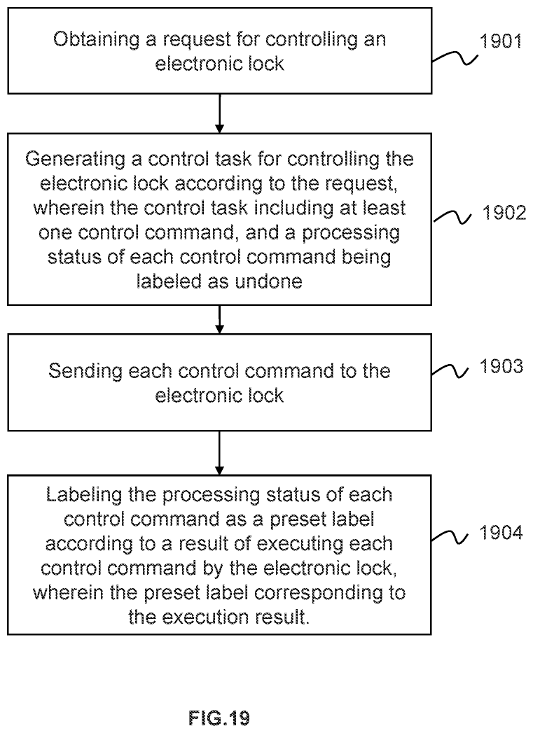

In 203, the server 110 may generate a control command based on the control request, transmit the control command to a target terminal, and labeling a processing status of the control command based on an execution result of the control command. In some embodiments, the server 110 may generate a control task for controlling the target device based on the received control request. The control task may include at least one control command. The at least one control command may be intended for controlling the target device (e.g., the smart device 130), such as downloading the user feature information to the target device, freezing, unfreezing, or deleting the user feature information (e.g., fingerprint information, iris information, or face information, etc.) stored in the target device, or modifying the period of validity of the user feature information. The server 110 may label the processing status of the control command at different stages. The processing status may include an intermediate status and/or a final status. For example, the processing status of the control command may be labeled as “undone” when the control command is generated at the beginning. Then the server 110 may send the control command to the target device. The target device may execute the received control command, and send a feedback related to a result of the execution to the server 110. The server 110, based on the feedback, may update the processing status of the control command. For example, after the control command is sent to the target device and before the target device executes the control command, the processing status of the control command may be labeled as “sent”. After the smart device executes the control command, the processing status of the control command may be labeled as “done”. The server 110 may directly transmit the control command and/or related data to the target device. Alternatively, the server 110 may transmit the control command to the control medium, and then the control medium may transmit the control command to the target device. In some embodiments, the server 110 may also send the processing status of the control command to a terminal device such that the terminal device can display the processing status of the control command. More descriptions about the server receiving the control request, generating the control command based on the control request, and labeling the control command as different processing status, may be found elsewhere in the present disclosure. See, for example, FIGS. 19 to 28 and the descriptions thereof.

FIG. 3 is a block diagram illustrating an exemplary server according to some embodiments of the present disclosure. In some embodiments, the server 300 may be an example of the server 110 illustrated in FIG. 1. The server 300 may include a receiving module 310, a storage module 320, a command generation module 330, a command status labeling module 320, and a sending module 350.

The receiving module 310 may be configured to receive an information and/or data. In some embodiments, the receiving module 310 may receive uploaded user feature information. In some embodiments, the receiving module 310 may further receive an uploaded identification of the user corresponding to the user feature information. The user feature information and/or the identification of the user may be collected and directly uploaded by a terminal device, or may be sent to a control medium by the terminal device and then sent to the receiving module 310 by the control medium. In some embodiments, the user feature information and/or the identification of the user received by the receiving module 310 may be encrypted information. The receiving module 310 may decrypt the encrypted information. In some embodiments, the receiving module 310 may encrypt the decrypted information again. In some embodiments, the receiving module 310 may receive an uploaded control request for controlling a target device. The control request may be a request for controlling the target device to manage the user feature information. For example, the control request may be a request for sending, freezing, or unfreezing the user feature information, or modifying the period of validity of the user feature information.

The storage module 320 may be configured to store information and/or data. In some embodiments, the storage module 320 may store information and/or data received by the receiving module 310. In some embodiments, the storage module 320 may store information and/or data generated by other modules in the information management system 300. For example, a control command generated by the command generation module 330 may be stored in the storage module 320. As another example, processing status of the control command generated by the command status labeling module 340 may be stored in the storage module 320.

The command generation module 330 may be configured to generate a control command. In some embodiments, the command generation module 330 may generate a control task for controlling the target device according to the control request received by the receiving module 310. The control task may include at least one control command. The control command may be intended for controlling the target device (e.g., the smart device 130), such as downloading the user feature information to the target device, freezing, unfreezing, or deleting the user feature information (e.g., fingerprint information, iris information or face information, etc.) stored in the target device, or modifying the period of validity of the user feature information.

The command status labeling module 340 may be configured to label a processing status of the control command. The command status labeling module 340 may label the processing status at different stages. The processing status may include an intermediate status and a final status. For example, the processing status of the control command may be labeled as “undone” when the control command is generated at the beginning. After the control command is sent to the target device, the command status labeling module 340 may update the processing status of the control command according to an execution result of the control command. For example, after the control command is sent to the target device and before the target device executes the control command, the command status labeling module 340 may update the processing status of the control command as “sent”. After the target device executes the control command, the command status labeling module 340 may update the processing status of the control command as “done”.

The sending module 350 may be configured to send information and/or data. In some embodiments, after the command generation module 330 generates the control command, the sending module 350 may send the control command. In some embodiments, the sending module 350 may acquire and send the information and/or data stored in the storage module 320. For example, the sending module 350 may acquire and send user feature information stored in the storage module 320 to a target device. In some embodiments, the sending module 350 may directly send information and/or data to the target device, or send the information and/or data to the control medium first, and then the control medium may send the information and/or data to the target device.

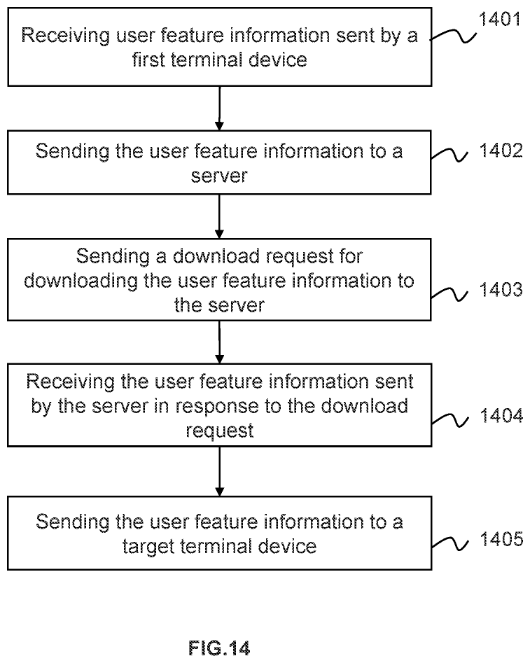

The technical solution for sending user feature information to the server for storage is further described below, wherein, FIGS. 4 to 13 are described from a perspective of the server, and FIGS. 14 to 18 are described from a perspective of the control medium.

FIG. 4 is a flowchart illustrating an exemplary process for an information processing method according to some embodiments of the present disclosure. The process may be implemented by the server 300 illustrated in FIG. 3. In some embodiments, the process illustrated in FIG. 4 may be implemented in the information management system 100 illustrated in FIG. 1 (e.g., by the server 110). For example, the process illustrated in FIG. 4 may be stored in a storage device (e.g., the storage device 150, a ROM, a RAM) in the form of instructions, and invoked and/or executed by one or more processors of the server 110.

In 401, the server 110 may receive user feature information. The user feature information may be used to verify identity of a user. The user feature information may be biometric information of the user, including but not limited to, fingerprint information, iris information, palm vein information, facial information, sound information, etc. In some embodiments, the user feature information may include non-biological information of the user, such as a password, motion (e.g., a gesture of the user), etc. In some embodiments, the user feature information may further include a predetermined code set by an administrator of the first terminal device. An unauthorized user may gain access to the first terminal device (e.g., access to operate the first terminal device) by inputting the predetermined code. The user feature information may be acquired by a terminal device, and then directly transmitted to the server 110 by the terminal device. Alternatively, the user feature information may be transmitted to a control medium first, and then transmitted to the server 110 by the control medium. In some embodiments, the user feature information may be transmitted to the server 110 after being encrypted. In some embodiments, in addition to the user feature information, the server 110 may receive an identification of the user corresponding to the user feature information. The identification of the user may be obtained and transmitted by the terminal device and/or the control medium. In some embodiments, the user feature information and the identification of the user identification may constitute a user feature file and to the server 110.

In 402, the server 110 may store the user feature information. The server 110 may store the user feature information in plaintext, or store the user feature information after encrypting it. In some embodiments, when the user feature information received by the server 110 is encrypted, the server 110 may store it after decrypting it. Alternatively, the server 110 may encrypt the user feature information in other manners after decrypting it, and then store it.

In 403, the server 110 may transmit the user feature information to a target terminal in response to receiving a request for obtaining the user feature information. The target terminal may be an electronic device such as a mobile phone, a door lock, an access control device, etc. An operator may initiate the request using the target terminal or any other terminal devices. The request may be transmitted to the server 110 by the terminal device directly or through the control medium. The request may carry the identification of the user, so that the server 110 may retrieve the user feature information corresponding to the identification of the user from feature information of a plurality of users. The server 110 may send the user feature information directly to the target terminal, or may send to the target terminal via the control medium.

It should be noted that although the process illustrated in FIG. 4 may be implemented by a control medium without the server involved. For example, the control medium may receive user feature information and store the user feature information. In some embodiments, the control medium may receive the user feature information from a first terminal device. Then the control medium may receive a request for obtaining the user feature information. In response to the request, the control medium may send the user feature information to a target terminal device. The target device and the first terminal device may be the same or different.

FIGS. 5 to 13 illustrate the methods and systems for information management by taking fingerprint feature information as an example according to some embodiments of the present disclosure. It should be understood that the present disclosure is not limited to fingerprint feature information, but may also be used for other feature information, such as iris information, palm vein information, facial information, sound information, etc., and may even be used for non-biological features, such as ordinary password information like digital passwords, motion information (e.g., a gesture of the user), etc.

FIG. 5 is a flowchart illustrating an exemplary process for an information processing method according to some embodiments of the present disclosure.

In 501, the server 110 may receive a fingerprint feature file transmitted by a control medium. The fingerprint feature file may include fingerprint feature information of a user and an identification of the user. The fingerprint feature information and the fingerprint feature file may be generated by a first terminal device and transmitted to the control medium by the first terminal device.

In some embodiments, the first terminal device may only transmit the fingerprint feature information to the control medium. Alternatively, the first terminal device may transmit both the fingerprint feature information and the identification of the user to the control medium. For example, if the first terminal device cannot obtain the identification of the user, the first terminal device may only transmit the fingerprint feature information to the control medium. If the first terminal device can obtain the identification of the user, the first terminal device may transmit both the fingerprint feature information and the identification of the user to the control medium. As another example, even if the first terminal device can obtain the identification of the user, the first terminal device may only transmit the fingerprint feature information to the control medium.

In the case that the first terminal device only transmits the fingerprint feature information to the control medium, the identification of the user may be obtain by the control medium. For example, the control medium may receive an identification of the user input by the user. As another example, the control medium may acquire identification information of the user (e.g., reading the identity card (i.e., ID card) information, collecting a user image, etc.).

The control medium may refer to a software and/or device that can communicate with the first terminal device. For example, the control medium may be a host computer, a mobile phone, a gateway, etc. As another example, the control medium may be an application installed in an electronic device.

The first terminal device may be an electronic device such as a mobile phone, a door lock, a fingerprint input device, an access control device, etc.

The control medium and the first terminal device may transmit data through a channel having a low data transmission rate such as a Bluetooth, a ZigBee, etc. Alternatively, the control medium and the first terminal device may transmit data through a channel having a high data transmission rate such as WiFi.

If the control medium communicates with the first terminal device through a channel having a low data transmission rate, the first terminal device may split the data (i.e., the fingerprint feature information or the fingerprint feature file) transmitted to the control medium into a plurality of data packets with a fixed length. The first terminal device may transmit the plurality of data packets to the control medium one by one.

In some embodiments, the first terminal device may collect user's fingerprint. The first terminal device may generate fingerprint feature information based on the collected fingerprint. The first terminal device may transmit the fingerprint feature information to the control medium. The first terminal device may transmit a fingerprint feature file including the fingerprint feature information and the identification of the user to the control medium. In some embodiments, the first terminal device may collect user's fingerprint in response to a fingerprint input instruction after receiving the fingerprint input instruction transmitted by the control medium. The first terminal device may generate fingerprint feature information based on the collected fingerprint. The first terminal device may transmit the fingerprint feature information to the control medium. In some embodiments, the first terminal device may collect user's fingerprint in response to a fingerprint input instruction after receiving the fingerprint input instruction transmitted by the control medium. The first terminal device may generate fingerprint feature information based on the collected fingerprint. The first terminal device may transmit a fingerprint feature file including the fingerprint feature information and the identification of the user to the control medium.

After receiving the fingerprint feature information or the fingerprint feature file transmitted by the first terminal device, the control medium may automatically send the fingerprint feature file to the server, or may send the fingerprint feature file to the server after receiving a transmission instruction initiated by the user.

The control medium may directly forward the fingerprint feature file to the server after receiving the fingerprint feature file transmitted by the first terminal device. Alternatively, the control medium may perform a simple verification process on the fingerprint feature file after receiving the fingerprint feature file transmitted by the first terminal device. For example, the control medium may determine whether a total data length of the fingerprint feature file is the same as a total data length reported by the first terminal device. If the total data lengths are the same, the verification is passed, otherwise the verification fails. The control medium may forward the fingerprint feature file to the server only when the verification is passed. Otherwise, the fingerprint feature file is prohibited from being forwarded to the server.

The control medium may directly transmit the fingerprint feature file including the fingerprint feature information and the identification of the user to the server after receiving the fingerprint feature information transmitted by the first terminal device. Alternatively, the control medium may perform a simple verification process on the fingerprint feature information after receiving the fingerprint feature information transmitted by the first terminal device. For example, the control medium may determine whether a total data length of the fingerprint feature information is the same as a total data length reported by the first terminal device. If the total data lengths are the same, the verification is passed, otherwise the verification fails. The control medium may forward the fingerprint feature file including the fingerprint feature information and the identification of the user to the server only when the verification is passed. Otherwise, the fingerprint feature file including the fingerprint feature information and the identification of the user is prohibited from being forwarded to the server.

While the first terminal device transmits the fingerprint feature file or the fingerprint feature information to the control medium, the fingerprint feature information may also be stored locally, so that the first terminal device may authenticate user identity by using the locally stored fingerprint feature information.

In 502, the server 110 may store the fingerprint feature file.

The server may store the fingerprint feature file in a plaintext form, or may store the fingerprint feature file in a ciphertext form. When the fingerprint feature file is stored in a ciphertext form, only part of the content of the fingerprint feature file may be encrypted, or the fingerprint feature file may be encrypted as a whole.

After receiving the fingerprint feature file sent by the control medium, the server may store the fingerprint feature file locally.

In 503, the server 110 may send the fingerprint feature information to the control medium when receiving a download request for downloading the fingerprint feature information sent by the control medium. The control medium may send the fingerprint feature information to a target terminal device. The target terminal device may be the first terminal device or a second terminal device. The second terminal device may be an electronic device such as a mobile phone, a door lock, an access control device, etc. Both the first terminal device and the second terminal device may have a fingerprint collection and fingerprint authentication function. The first terminal device and the second terminal device may be different electronic devices.

The download request for downloading the fingerprint feature information sent by the control medium to the server may be triggered by the user operating on the control medium.

The download request for downloading the fingerprint feature information sent by the control medium to the server may be triggered by the user operating on the first terminal device and sent to the control medium, or may be triggered by the user operating on the second terminal device and sent to the control medium. That is, the control medium may forward the download request for downloading the fingerprint feature information sent by the first terminal device or the second terminal device to the server.

If the download request for downloading the fingerprint feature information sent by the control medium to the server carries the identification of the user, the server may obtain the corresponding fingerprint feature information according to the identification of the user.

According to some embodiments of the present disclosure, when the first terminal device needs to use the fingerprint feature information (for the sake of description, it is recorded as the first fingerprint feature information) for user identity authentication while the first terminal device does not store the first fingerprint feature information locally (e.g., when the memory for storing the first fingerprint feature information in the first terminal device is replaced, or when the first terminal device is restored to the factory settings, etc.), the first fingerprint feature information may be downloaded from the server by the control medium, and the first fingerprint feature information may be sent to the first terminal device.

When the second terminal device needs to use the first fingerprint feature information for user identity authentication, the first fingerprint feature information may be downloaded from the server by the control medium, and the first fingerprint feature information may be sent to the second terminal device.

In some embodiments, in the case that the download request for downloading the fingerprint feature information is generated and transmitted by the control medium, after receiving the download request for downloading the fingerprint feature information and before sending the fingerprint feature information to the control medium, the server may first determine whether the control medium is authorized to download the fingerprint feature information. If the control medium is authorized to download the fingerprint feature information, the server may send the fingerprint feature information to the control medium. Otherwise, the fingerprint feature information may be prohibited from being sent to the control medium.

Further, in addition to determining whether the control medium is authorized to download the fingerprint feature information, the server may also determine whether the terminal device (i.e., the terminal device corresponding to the identification carried in the download request for downloading the fingerprint feature information) is authorized to download the fingerprint feature information. In other words, the server may send the fingerprint feature information to the control medium only when the terminal device and the control medium are authorized to download the fingerprint feature information. Otherwise, the fingerprint feature information may be prohibited from being sent to the control medium.

To determine whether the control medium is authorized to download the fingerprint feature information may be implemented as the following operations.

The server may determine whether an identification of the control medium carried in the download request for downloading the fingerprint feature information is a predetermined first identification.

If the result of the determination is yes, the server may be determine that the control medium is authorized to download the fingerprint feature information. Otherwise, the server may determine that the control medium is not authorized to download the fingerprint feature information.

To determine whether the terminal device is authorized to download the fingerprint feature information may be implemented as the following operations.

The server may determine whether an identification of the terminal device carried in the download request for downloading the fingerprint feature information is a predetermined second identification.

If the result of the determination is yes, it may be determined that the terminal device is authorized to download the fingerprint feature information. Otherwise, it may be determined that the terminal device is not authorized to download the fingerprint feature information.

In some embodiments, in the case that the download request for downloading the fingerprint feature information is generated and transmitted by the terminal device, after receiving the download request for downloading the fingerprint feature information and before sending the fingerprint feature information to the control medium, the server may first determine whether the terminal device is authorized to download the fingerprint feature information. If the terminal device is authorized to download the fingerprint feature information, the server may send the fingerprint feature information to the control medium. Otherwise, the fingerprint feature information may be prohibited from being sent to the control medium.

Further, in addition to determining whether the terminal device is authorized to download the fingerprint feature information, the server may also determine whether the control medium is authorized to download the fingerprint feature information. In other words, the server may send the fingerprint feature information to the control medium only when the terminal device and the control medium are authorized to download the fingerprint feature information. Otherwise, the fingerprint feature information may be prohibited from being sent to the control medium.

According to the information processing method provided in the present disclosure, after the first terminal device generates the fingerprint feature information, the fingerprint feature file containing the fingerprint feature information may be sent to the server by the control medium for storage. Therefore, when the memory for storing the fingerprint feature information on the first terminal device is damaged and replaced with a new memory, the fingerprint feature information may be downloaded from the server by the control medium, and the fingerprint feature information may be sent to the first terminal device. The user identity authentication can be realized without the first terminal device user re-inputting the fingerprint to form a new fingerprint feature information, thereby improving convenience for the user.

Similarly, when the second terminal device needs to use the first fingerprint feature information for user identity authentication, the first fingerprint feature information may be downloaded from the server by the control medium, and the first fingerprint feature information may be sent to the second terminal device. There is no need to input a fingerprint multiple times in the second terminal device to generate new fingerprint feature information, thereby improving convenience for the user.

In addition, a communication connection between the server and the terminal device(s) may be established by the control medium. The data transmission between the control medium and the terminal device(s) may be carried out at a low-rate, and the data transmission between the control medium and the server may carried out at a high rate via a high-rate network. On one hand, the information processing method provided by the present disclosure may be applied as long as the low-rate data transmission between the terminal device(s) and the control medium can be performed, the configuration of the terminal device(s) may be relatively low, thereby reducing the cost of the terminal device(s). On the other hand, in some application scenarios where fingerprint feature information is updated frequently (e.g., in a hotel of which the frequency of updating the fingerprint feature information of the door lock is relatively high), the administrator may manage the collection, storage, and distribution of the fingerprint feature information through the control medium (e.g., a computer on a front desk), which is convenient for the administrator to operate.

In addition, after receiving the download request for downloading the fingerprint feature information, the server may not directly send the fingerprint feature information to the control medium, but send the fingerprint feature information to the control medium after determining that the control medium and/or the terminal device is/are authorized to download. Otherwise, the fingerprint feature information may not be sent to the control medium, which further improves the security of the fingerprint feature information.

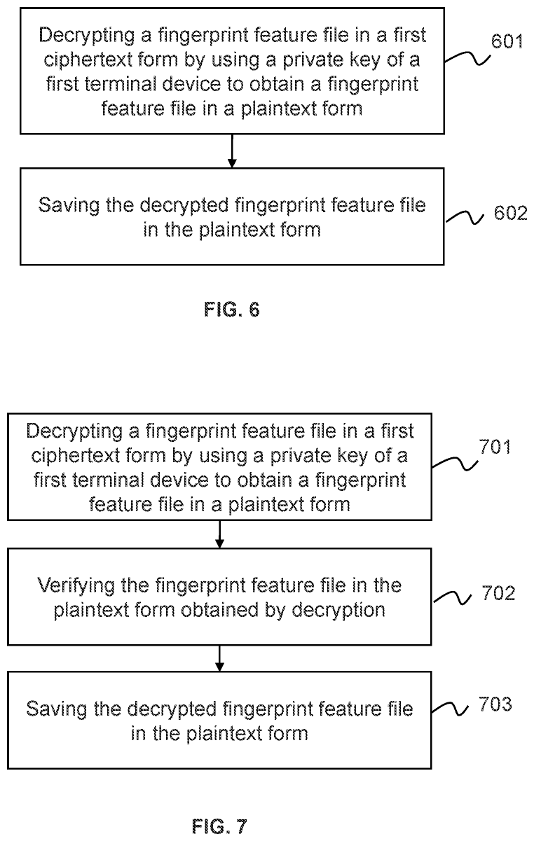

FIG. 6 is a flowchart illustrating an exemplary process for storing a received fingerprint feature file by the server according to some embodiments of the present disclosure. In some embodiments, the control medium may further send an identification of the first terminal device to the server. In the case that the first terminal device sends a fingerprint feature file to the control medium, the fingerprint feature file may be a fingerprint feature file in a first ciphertext form. Accordingly, an exemplary process for the server storing received fingerprint feature file may be illustrated in FIG. 6. The process may include:

In 601, the server may decrypt a fingerprint feature file in a first ciphertext form using a private key of a first terminal device to obtain a fingerprint feature file in a plaintext form.

In some embodiments of the present disclosure, the fingerprint feature file in the first ciphertext form may be obtained by the first terminal device encrypting the fingerprint feature file in the plaintext form using the private key of the first terminal device.

The server may store in advance a correspondence between the identification(s) of at least one terminal device and the private key(s) of the at least one terminal device. The server may determine the private key of the first terminal device according to the correspondence and the identification of the first terminal device transmitted by the control medium.

The server may also store a decryption algorithm corresponding to an encryption algorithm that the first terminal device performs an encryption using the private key of the first terminal device.

In 602, the server may save the fingerprint feature file in the plaintext form obtained by decryption.

It should be noted that, in this embodiment, that the server may save the fingerprint feature file in the plaintext form does not specifically refer to that the server may save, in the plaintext form, the fingerprint feature file, but refers to that the server may save the fingerprint feature file obtained by the decryption. Specifically, when the fingerprint feature file obtained by the decryption is saved, the fingerprint feature file obtained by the decryption may be saved in the plaintext form, or a ciphertext form.

In the process for saving the fingerprint feature file in the plaintext form, if the fingerprint feature file is saved in the plaintext form, the server may encrypt the fingerprint feature file in the plaintext form into a fingerprint feature file in a second ciphertext form, and save the fingerprint feature file in the second ciphertext form. That is, the fingerprint feature file is saved in the second ciphertext form. Private key used to obtain the fingerprint feature file in the first ciphertext form is different from the private key used to obtain the fingerprint feature file in the second ciphertext form. The encryption algorithm used to obtain the fingerprint feature file in the second ciphertext form and the fingerprint feature file in the first ciphertext form may be the same or different.

If the first terminal device splits the fingerprint feature file into multiple data packets and then uploads them to the control medium, the first terminal device may encrypt each data packet and uploads it to the control medium.

In some embodiments of the present disclosure, in the process that the first terminal device sends the fingerprint feature file to the control medium, the fingerprint feature file is encrypted using the private key of the first terminal device. Therefore, it avoids the security problem that after the control medium is cracked by a third-party, the received fingerprint feature file is separately and maliciously saved in and applied to other terminal devices.

FIG. 7 is a flowchart illustrating an exemplary process for storing a received fingerprint feature file by the server according to some embodiments of the present disclosure. In some embodiments, the control medium may further send an identification of the first terminal device to the server. In the case that the first terminal device sends a fingerprint feature file to the control medium, the fingerprint feature file may be a fingerprint feature file in a first ciphertext form.

In 701, the server may decrypt a fingerprint feature file in the first ciphertext form using a private key of a first terminal device to obtain a fingerprint feature file in a plaintext form.

More descriptions about operation 701 may be found in connection with operation 601, and are not repeated.

In 702, a verification process may be performed on the fingerprint feature file in the plaintext form obtained by the decryption. In response to that the verification is passed, operation 703 may be performed, otherwise the process may end.

In some embodiments, at the same time that the first terminal device uploads the fingerprint feature file to the control medium, the first terminal device may also upload verification information corresponding to the fingerprint feature file in the plaintext form to the control medium. The verification information may include a data length of the fingerprint feature file in a plaintext form, and a check value calculated by using the fingerprint feature file in the plaintext form, such as a CRC check value or an MD5 value, etc. During the verification process performed on the fingerprint feature file in a plaintext form obtained by decryption by the server, the server may perform the verification process on the fingerprint feature file in the plaintext form by using the data length and the check value. Only when the data length and the check value of the fingerprint feature file in the plaintext form obtained by the decryption are the same as the data length and the check value uploaded by the first terminal device, the verification is passed, otherwise, the verification fails.

In 703, the server may save the fingerprint feature file in the plaintext form obtained by the decryption.

More descriptions about operation 703 may be found in connection with operation 602.

Different from the embodiment shown in FIG. 6, in this embodiment, after obtaining obtain the fingerprint feature file in the plaintext form by decryption, and before saving fingerprint feature file in the plaintext form by decryption, the server may perform a verification process on the fingerprint feature file in the plaintext form obtained by decryption. The server may save the fingerprint feature file in the plaintext form obtained by decryption only when the verification is passed, otherwise, the server may not save the fingerprint feature file in the plaintext form obtained by decryption, thereby ensuring the integrity and validity of the stored fingerprint feature file.

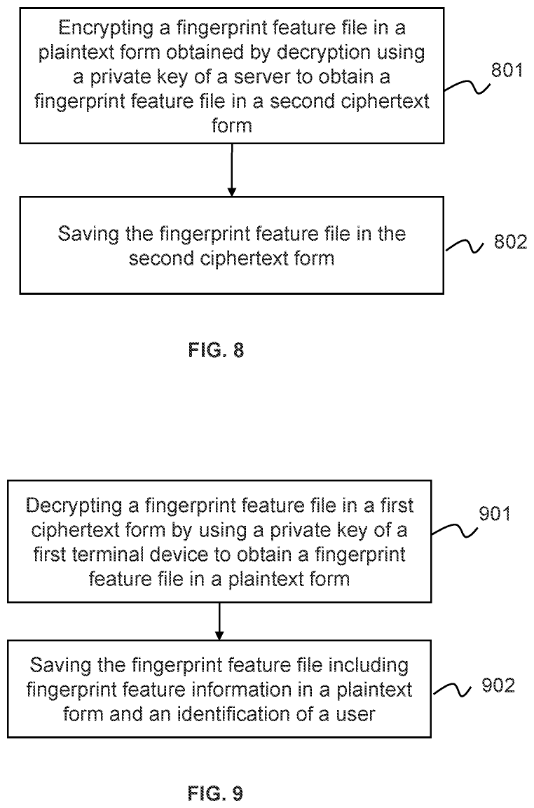

FIG. 8 is a flowchart illustrating an exemplary process for storing a fingerprint feature file in the plaintext form obtained by decryption according to some embodiments of the present disclosure.

In 801, the server may encrypt a fingerprint feature file in the plaintext form obtained by decryption using a private key of the server to obtain a fingerprint feature file in a second ciphertext form.

In 802, the server may save the fingerprint feature file in the second ciphertext form.

The server may calculate a feature code of the identification of the user included in the fingerprint feature file using a preset algorithm. The server may save the feature code in association with the fingerprint feature file in the second ciphertext form.

In some embodiments of the present disclosure, the server may save the fingerprint feature file in the ciphertext form which prevents the fingerprint feature file from being maliciously applied when the server is maliciously accessed.

In addition, if the fingerprint feature file received by the server is the fingerprint feature file in the ciphertext form, the encryption mode used when the server stores the fingerprint feature file locally is different from the encryption mode used when the fingerprint feature file is transmitted. The security in a flow of the fingerprint feature file is improved by using multiple encryption modes.

In some embodiments, the storing the fingerprint feature file in a plaintext form obtained by decryption may be implemented as following operations. The server may encrypt the fingerprint feature information in the fingerprint feature file using the private key of the server to obtain the fingerprint feature information in the second ciphertext form. The encryption algorithm used to obtain the fingerprint feature information in the second ciphertext form and the fingerprint feature file in the second ciphertext form may be the same or different.

The server may save the identification of the user in the fingerprint feature file or the feature code of the identification of the user in association with the fingerprint feature information in the second ciphertext form.

FIG. 9 is a flowchart illustrating an exemplary process for storing a fingerprint feature file by the server according to some embodiments of the present disclosure. In some embodiments, the control medium may also send an identification of the first terminal device to the server. In the case that fingerprint feature information is generated by the first terminal device and transmitted to the control medium by the first terminal device, the fingerprint feature file may include fingerprint feature information in a first ciphertext form, an identification of the user, and an identification of the first terminal device. That is to say, the first terminal device may only send the fingerprint feature information in the first ciphertext form to the control medium.

In 901, the server may decrypt the fingerprint feature information in a first ciphertext form using a private key of a first terminal device to obtain fingerprint feature information in a plaintext form.

In the embodiment of the present disclosure, the first terminal device may encrypt the fingerprint feature information in the plaintext form using the private key of the first terminal device to obtain the fingerprint feature information in the first ciphertext form.

After receiving the fingerprint feature information in the first ciphertext form, the control medium may send a fingerprint feature file including the fingerprint feature information in the first ciphertext form and the identification of the user corresponding to the fingerprint feature information to the server.

The server may store in advance a correspondence between the identification(s) of at least one terminal device and the private key(s) of the at least one terminal device. The server may determine the private key of the first terminal device according to the correspondence and the identification of the first terminal device carried in the fingerprint feature file.

The server may store a decryption algorithm corresponding to an encryption algorithm that the first terminal device performs an encryption using the private key of the first terminal device.

After receiving the fingerprint feature file, the server may decrypt the fingerprint feature information in the first ciphertext form included in the fingerprint feature file by using the private key of the first terminal device to obtain the fingerprint feature information in the plaintext form.

In 902, the server may save the fingerprint feature file including the fingerprint feature information in the plaintext form and the identification of the user.

In some embodiments of the present disclosure, in the process that the first terminal device sends the fingerprint feature information to the control medium, the fingerprint feature information is encrypted by using the private key of the first terminal device. Therefore, it avoids the security problem that after the control medium is cracked by a third-party and the received fingerprint feature information is separately and maliciously saved in and applied to other terminal devices.

Since the technique for obtaining the identification of the first terminal device by the control medium is already mature, it will not be described in detail in the present disclosure.

In some embodiments, after obtaining the fingerprint feature information in the plaintext form, and before saving the fingerprint feature file including the fingerprint feature information in the plaintext form and the identification of the user, a verification process may be performed on the fingerprint feature information in the plaintext form.

In response to that the verification is passed, the server may save the fingerprint feature file including the fingerprint feature information in the plaintext form and the identification of the user.

In some embodiments, the fingerprint feature file including the fingerprint feature information in the plaintext form and the identification of the user may be saved only when the fingerprint feature information is verified, thereby ensuring the integrity and validity of the stored fingerprint feature information.

In some embodiments, the process for saving the fingerprint feature file including the fingerprint feature information in the plaintext form and the identification of the user may be implemented as following operations.

The server may encrypt the fingerprint feature file including the fingerprint feature information in the plaintext form and the identification of the user using the private key of the server to obtain a fingerprint feature file in a second ciphertext form. The encryption algorithms used to obtain the fingerprint feature file in the second ciphertext form and the fingerprint feature file in the first ciphertext form may be the same or different.

The server may save the fingerprint feature file in the second ciphertext form.

A feature code of the identification of the user in the fingerprint feature file may be calculated by a preset algorithm. The server may save the feature code in association with the fingerprint feature file in the second ciphertext form.

In this embodiment, the server may save the fingerprint feature file in the ciphertext form which prevents the fingerprint feature file from being maliciously applied when the server is maliciously accessed.

In some embodiments, saving the fingerprint feature file including the fingerprint feature information in the plaintext form and the identification of the user may be implemented as following operations.

The server may encrypt the fingerprint feature information in the plaintext form using the private key of the server to obtain the fingerprint feature information in a second ciphertext form. The encryption algorithms used to obtain the fingerprint feature information in the second ciphertext form and the fingerprint feature file in the first ciphertext form may be the same or different.

The identification of the user or the feature code of the identification of the user may be saved in association with the fingerprint feature information in the second ciphertext form.

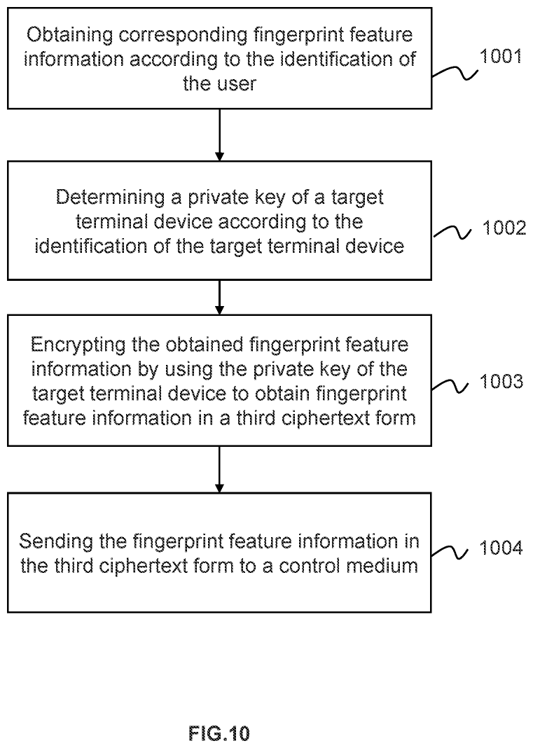

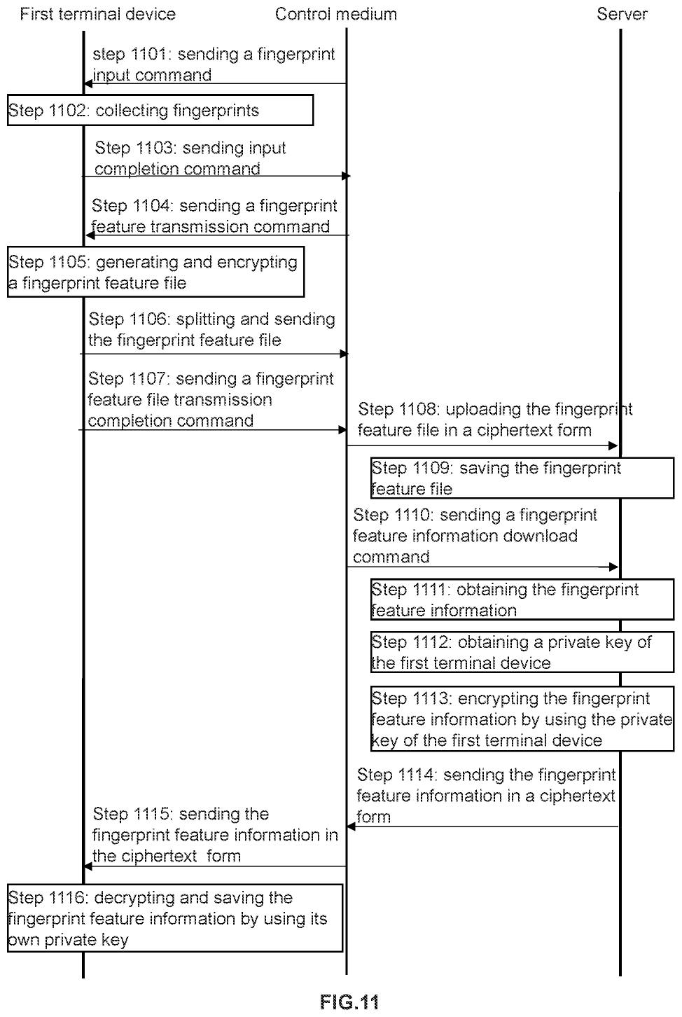

FIG. 10 is a flowchart illustrating an exemplary process for transmitting fingerprint feature information to the control medium according to some embodiments of the present disclosure. In some embodiments, a download request for downloading fingerprint feature information may carry an identification of a target terminal device and an identification of a user. The identification of the target terminal device may be manually input into the control medium by a user, or may be selected by a user from a list device identifications provided by the control medium.

In 1001, the server may obtain a corresponding fingerprint feature information according to the identification of the user.

In 1002, the server may determine a private key of the target terminal device according to the identification of the target terminal device.

The private key corresponding to the identification of the target terminal device may be determined according to a preset correspondence between the identification(s) of at least one target terminal device and the private key(s) of the at least one target terminal device.

The execution order of operation 1001 and operation 1002 is not specifically limited. Operation 1001 may be executed first, then operation 1002 may be executed. Alternatively, operation 1002 may be executed first, then operation 1001 may be executed. Alternatively, the two operations may be executed simultaneously.

In 1003, the server may encrypt the obtained fingerprint feature information using a private key of the target terminal device to obtain fingerprint feature information in a third ciphertext form. The encryption algorithms used to obtain the fingerprint feature information in the third ciphertext form and the fingerprint feature file in the first ciphertext form may be the same or different. That is, the fingerprint feature information in the third ciphertext form may be the fingerprint feature information in the first ciphertext form, or may not be the fingerprint feature information in the first ciphertext form.

The target terminal device may store a decryption algorithm corresponding to an encryption algorithm which is used by the server to encrypt the fingerprint feature file using the private key of the target terminal device.

It should be noted that when the server stores the fingerprint feature file, it may store the fingerprint feature file in a plaintext form or a ciphertext form.

If the server stores the fingerprint feature file in the plaintext form, the server may directly extract the fingerprint feature information from the fingerprint feature file, and encrypt the extracted fingerprint feature information using the private key of the target terminal device to obtain the fingerprint feature information in the third ciphertext form.

If the server stores the fingerprint feature file in the ciphertext form, the server may first decrypt the fingerprint feature file using the private key of the server to obtain the fingerprint feature file in the plaintext form. Then, the server may extract the fingerprint feature information from the fingerprint feature file in the plaintext form, and encrypt the extracted fingerprint feature information using the private key of the target terminal device to obtain the fingerprint feature information in the third ciphertext form.

In 1004, the server may send the fingerprint feature information in the third ciphertext form to the control medium. The control medium may send the fingerprint feature information in the third ciphertext form to the target terminal device.

After receiving the fingerprint feature information in the third ciphertext form, the control medium may directly forward the fingerprint feature information in the third ciphertext form to the target terminal device.

FIG. 11 is a flowchart illustrating an exemplary process for an information processing method according to some embodiments of the present disclosure.

In 1101, a fingerprint input command may be sent by a control medium to a first terminal device.

The fingerprint input command may be triggered by the control medium user operating on the control medium.

In 1102, in response to the fingerprint input command, the first terminal device may initiate a fingerprint input process to collect a fingerprint. User A may press a fingerprint sensor of the first terminal device by using a same finger multiple times according to an operation prompt. A fingerprint processing chip of the first terminal device may perform a feature extraction on the fingerprint(s) collected by the fingerprint sensor to obtain fingerprint feature information of the user A.

In 1103, an input completion command may be sent by the first terminal device to the control medium.

In 1104, a fingerprint feature file transmission command may be sent by the control medium to the first terminal device.

The fingerprint feature file transmission command may be triggered by the control medium user operating on the control medium, or may be automatically generated after the control medium receives the input completion command.

In 1105, in response to the fingerprint feature file transmission command, a fingerprint feature file may be generated and encrypted by the first terminal device.

The fingerprint feature file may include the fingerprint feature information of the user A and the identification of the user A (for the sake of description, it is recorded as the first user identification). The first user identification may be manually input by the user to the first terminal device, or automatically collected by the first terminal device.

The first terminal device may encrypt the fingerprint feature file using its own private key.

Alternatively, before encrypting the fingerprint feature file, a check value of the fingerprint feature file, such as a CRC check value, may be calculated. After calculating the check value, the fingerprint feature file may be encrypted.

In 1106, the fingerprint feature file in a ciphertext form may be split into a plurality of data packets and may be sent by the first terminal device to the control medium.

Alternatively, if the check value is calculated, the first terminal device may also send the check value to the control medium. The check value may be included in a data packet and sent to the control medium, or sent to the control medium as a separate data packet.

In 1107, a fingerprint feature file transmission completion command may be sent by the first terminal device to the control medium after all the data packets are sent to the control medium.

In 1108, the fingerprint feature file in the ciphertext form may be sent by the control medium to the server after receiving the fingerprint feature file transmission completion command.

In 1109, after receiving the fingerprint feature file in the ciphertext form, the server may decrypt the fingerprint feature file in the ciphertext form using a private key of the first terminal device and save the decrypted fingerprint feature file.

Alternatively, if the control medium also transmits the check value, a verification process may first be performed on the fingerprint feature file obtained by the decryption by using the check value after the server decrypts the fingerprint feature file. The fingerprint feature file may be saved when the verification is passed.

When the server saves the decrypted fingerprint feature file, the fingerprint feature information may be saved in a plaintext form or a ciphertext form. In the case that the fingerprint feature file is saved in the ciphertext form, the server may encrypt the fingerprint feature information in the fingerprint feature file in the plaintext form using the private key of the server. The encrypted fingerprint feature information may be saved associated with the identification of the user.

The above operations are a specific implementation process for uploading the fingerprint input and fingerprint feature file. The process for sending the fingerprint feature information may be described below.

In 1110, a fingerprint feature information download command may be sent by the control medium to the server. The fingerprint feature information download command may include a first user identification (i.e., the identification of the user A) and an identification of the first terminal device.

In 1111, a corresponding fingerprint feature information (i.e., the user A's fingerprint feature information) may be obtained by the server according to the first user identification after receiving the fingerprint feature information download command. If the obtained fingerprint feature information is in the ciphertext form, the fingerprint feature information in the ciphertext form may be decrypted by using the private key of the server to obtain the fingerprint feature information in the plaintext form.

In 1112, the private key of the first terminal device may be acquired by the server using the identification of the first terminal device.

In 1113, the fingerprint feature information in the plaintext form may be encrypted by the server using the private key of the first terminal device.

Optionally, before encrypting the fingerprint feature information in the plaintext form, the check value of the fingerprint feature information in the plaintext form may be calculated, and then the fingerprint feature information in the plaintext form may be encrypted.

In 1114, the fingerprint feature information in the ciphertext form may be sent by the server to the control medium.

Optionally, if the server also calculates the check value, the check value may be sent to the control medium together.

In 1115, the fingerprint feature information in the ciphertext form may be split into a plurality of data packets and may be sent by the control medium to the first terminal device.

In 1116, the fingerprint feature information in the ciphertext form may be decrypted by the first terminal device using its own private key. The fingerprint feature information in the ciphertext form may be saved by the first terminal device then.

Optionally, if the server further sends the check value, the first terminal device may perform a verification process on the fingerprint feature information obtained by the decryption using the check value.

Operations 1110 to 1116 illustrate the process in which the control medium downloads the fingerprint feature information of the user A required by first terminal device from the server. The process in which the control medium downloads the fingerprint feature information of the user A required by the second terminal device from the server may be described below.

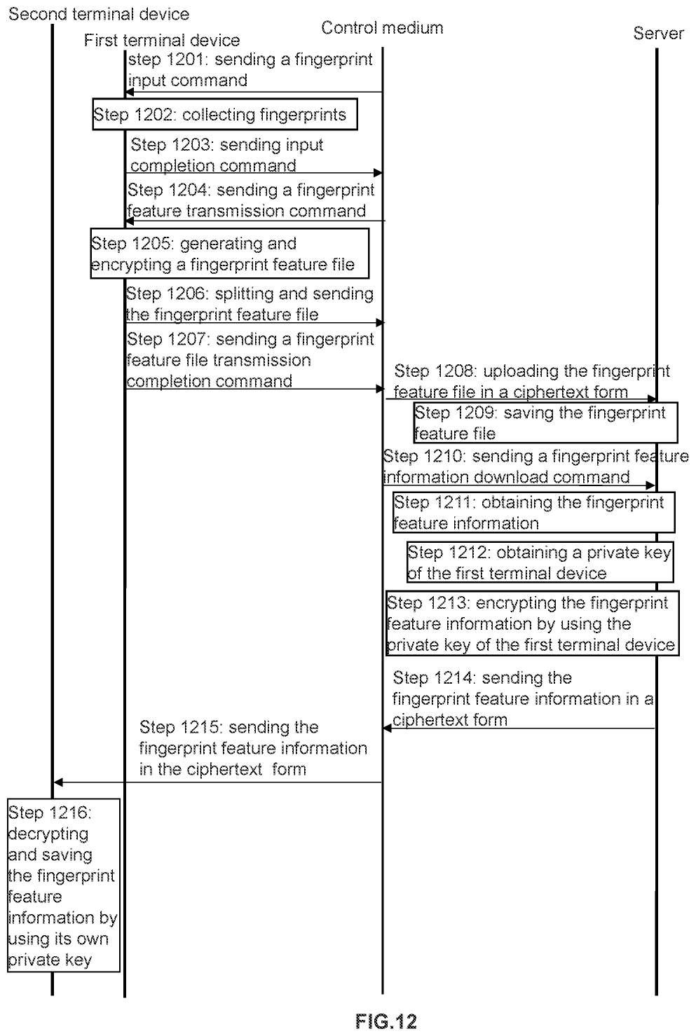

FIG. 12 is a flowchart illustrating an exemplary process for an information processing method according to some embodiments of the present disclosure.

In 1201, a fingerprint input command may be sent by a control medium to a first terminal device.

In 1202, in response to the fingerprint input command, the first terminal device may initiate a fingerprint input process to collect a fingerprint.

In 1203, an input completion command may be sent by the first terminal device to the control medium.

In 1204, a fingerprint feature file transmission command may be sent by the control medium to the first terminal device.

In 1205, in response to the fingerprint feature file transmission command, a fingerprint feature file may be generated and encrypted by the first terminal device.

The fingerprint feature file may include the fingerprint feature information of the user A and the identification of the user A (for the sake of description, it is recorded as the first user identification). The first user identification may be manually input by the user to the first terminal device, or automatically collected by the first terminal device.

In 1206, the fingerprint feature file in a ciphertext form may be split into a plurality of data packets and may be sent by the first terminal device to the control medium.

In 1207, a fingerprint feature file transmission completion command may be sent by the first terminal device to the control medium after all the data packets are sent to the control medium.

In 1208, the fingerprint feature file in the ciphertext form may be sent by the control medium to the server after receiving the fingerprint feature file transmission completion command.

In 1209, after receiving the fingerprint feature file in the ciphertext form, the server may decrypt the fingerprint feature file in the ciphertext form by using a private key of the first terminal device and save the decrypted fingerprint feature file.

More descriptions about the implementation process of operations 1201 to 1209 may be found in connection with operations 701 to 709.

In 1210, a fingerprint feature information download command may be sent by the control medium to the server. The fingerprint feature information download command may include the first user identification (i.e., the identification of the user A) and an identification of a second terminal device.

In 1211, a corresponding fingerprint feature information (i.e., the user A's fingerprint feature information) may be obtained by the server according to the first user identification after receiving the fingerprint feature information download command. If the obtained fingerprint feature information is in the ciphertext form, the fingerprint feature information in the ciphertext form may be decrypted by using the private key of the server to obtain the fingerprint feature information in the plaintext form.

In 1212, a private key of the second terminal device may be acquired by the server using the identification of the second terminal device.

In 1213, the fingerprint feature information in the plaintext form may be encrypted by the server using the private key of the second terminal device.

Optionally, before encrypting the fingerprint feature information in the plaintext form, the check value of the fingerprint feature information in the plaintext form may be calculated, and then the fingerprint feature information in the plaintext form may be encrypted.

In 1214, the fingerprint feature information in the ciphertext form may be sent by the server to the control medium.

Optionally, if the server also calculates the check value, the check value may be sent to the control medium together.

In 1215, the fingerprint feature information in the ciphertext form may be split into a plurality of data packets and may be sent by the control medium to the second terminal device.

In 1216, the fingerprint feature information in the ciphertext form may be described by the second terminal device using its own private key. The fingerprint feature information in the ciphertext form may be saved by the second terminal device then.

Optionally, if the server further sends the check value, the second terminal device may perform a verification process on the fingerprint feature information obtained by the decryption using the check value.

The application scenario of the present disclosure is exemplified below.

Application Scenario 1.

If the unlocking mode of the mobile phone of user A is a fingerprint unlocking mode, the user A inputs the fingerprint multiple times (for example, 3 times) according to a mobile phone prompt. The mobile phone generates fingerprint feature information according to the collected fingerprints, and save the fingerprint feature information locally. At the same time, a fingerprint feature file including the fingerprint feature information and a mobile phone identification (e.g., a mobile number, or a UIM card identifier, etc.) is uploaded to the server through a control medium (e.g., a router, a gateway server, or a software in the mobile phone, etc.). The server saves the received fingerprint feature information associated with the identification of the mobile phone of user A. If the memory card of user A's mobile phone has a problem and cannot be read, and a new memory card needs to be replaced, the previously stored fingerprint feature information will be lost after replacing the new memory card. At this time, the user A does not have to re-input the fingerprint so that the mobile phone generates the fingerprint feature information, but directly downloads the previously uploaded fingerprint feature information from the server through the control medium.

Application Scenario 2.

A user B wants to check in a hotel, and the user B inputs a fingerprint on a fingerprint input device at the front desk when checking in at the front desk. The fingerprint input device generates fingerprint feature information by using the fingerprint. The fingerprint feature information is encrypted by using a private key of the fingerprint input device and sent to the computer at the front desk. The computer uploads the fingerprint feature information in a ciphertext form to the server in association with the identification of the user B (such as the ID number).

After receiving the fingerprint feature information in the ciphertext form and the ID number of the user B, the server decrypts the fingerprint feature information in the ciphertext form by using the private key of the fingerprint input device to obtain the fingerprint feature information in a plaintext form. The server may encrypt a fingerprint feature file including the fingerprint feature information in the plaintext form and the ID number of user B with the private key of the server and then save the encrypted fingerprint feature file locally. Before saving, the server may calculate a feature code of the identification of the user B using a preset algorithm. The server may save the feature code in association with the fingerprint feature file in the ciphertext form.

The front desk staff initiates the computer to send a download request to the server for downloading the user fingerprint feature information by operating the computer. The download request carries the ID number of the user B and an identification of the door lock of the first room assigned to the user B.

After receiving the download request for downloading the fingerprint feature information of the user B, the server searches for the fingerprint feature file in the ciphertext form by using the feature code of the ID number of the user B, and decrypts the found fingerprint feature file in the ciphertext form. Then, the server finds the private key of the door lock of the first room using the identification of the door lock of the first room, and encrypts the fingerprint feature information in the decrypted fingerprint feature file using the private key of the door lock of the first room. The fingerprint feature information in the ciphertext form is sent to the computer.

After receiving the fingerprint feature information in the ciphertext form, the computer sends the fingerprint feature information in the ciphertext form to the door lock of the first room.

After receiving the fingerprint feature information in the ciphertext form, the door lock of the first room decrypts the fingerprint feature information in the ciphertext form by using its own private key and then saves the decrypted fingerprint feature information.

After the user B inputs the fingerprint in the door lock of the first room, the door lock of the first room extracts the feature of the input fingerprint, and authenticates the user B according to the extracted feature and the locally stored fingerprint feature information. If the authentication is passed, the door lock is unlocked, otherwise the door lock is forbidden to be unlocked. Merely by way of example, a front desk staff member may turn on an access suspension function (e.g., an electronic access suspension function) of the door lock through a computer. When a user attempts to unlock the door, even if the user provides accurate authentication information so that the authentication is successful, because the access suspension function is on, the door lock cannot be unlocked. Conversely, if the access suspension function is off, the door lock may be unlocked when a user provides accurate authentication information so that the authentication is successful.

In addition, after the user B enters the first room, when the user B is dissatisfied with the first room and wants to change the room, the front desk staff only needs to download user fingerprint feature information from the server again by using the computer, and send the downloaded fingerprint feature information to a door lock of a second room assigned to the user B again instead of the user B re-inputting the fingerprint at the front desk to form new fingerprint feature information.

Specifically, the front desk staff causes the computer to send a download request to the server for downloading the user fingerprint feature information by operating the computer. The download request carries the ID number of the user B and an identification of the door lock of the second room assigned to the user B.

After receiving the download request for downloading the fingerprint feature information of the user B, the server searches for the fingerprint feature file in the ciphertext form by using the feature code of the ID number of the user B, and decrypts the found fingerprint feature file in the ciphertext form. Then, the server finds the private key of the door lock of the second room using the identification of the door lock of the second room, and encrypts the fingerprint feature information in the decrypted fingerprint feature file using the private key of the door lock of the second room. The fingerprint feature information in the ciphertext form is sent to the computer.

After receiving the fingerprint feature information in the ciphertext form, the computer sends the fingerprint feature information in the ciphertext form to the door lock of the second room.

After receiving the fingerprint feature information in the ciphertext form, the door lock of the second room decrypts the fingerprint feature information in the ciphertext form by using its own private key and then saves the decrypted fingerprint feature information.

After the user B inputs the fingerprint at the door lock of the second room, the door lock of the second room extracts the feature of the input fingerprint, and authenticates the user B according to the extracted feature and the locally stored fingerprint feature information. If the authentication is passed, the door lock is unlocked, otherwise the door lock is forbidden to unlock.

After the fingerprint feature information of the user B is sent by the computer at the front desk, the computer may also send a command for deleting the fingerprint feature information of the user B to the door lock of the first room according to the operation of the front desk staff.

After receiving the command for deleting the fingerprint feature information of the user B, the door lock of the first room deletes the fingerprint feature information of the user B.

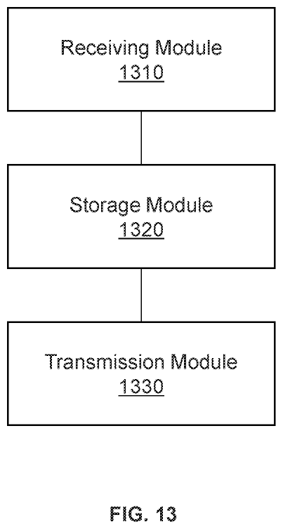

FIG. 13 is a block diagram illustrating an exemplary server according to some embodiments of the present disclosure.

In some embodiments, the present disclosure also provides a server. As shown in FIG. 13, the server may include a receiving module 1310, a storage module 1320, and a transmission module 1330.

The receiving module 1310 may be configured to receive a fingerprint feature file sent by a control medium. The fingerprint feature file may include fingerprint feature information and a user identification. The fingerprint feature information or the fingerprint feature file may be generated by the first terminal device and then uploaded to the control medium.

The storage module 1320 may be configured to store the fingerprint feature file.

The transmission module 1330 may be configured to send the fingerprint feature information to the control medium when receiving a download request for downloading the fingerprint feature information sent by the control medium, so that the control medium may send the fingerprint feature information to a target terminal device. The target terminal device may be the first terminal device or a second terminal device.

According to the server provided in the present disclosure, after the first terminal device generates the fingerprint feature information, the fingerprint feature file containing the fingerprint feature information may be sent to the server by the control medium for storage. Therefore, when the memory for storing the fingerprint feature information on the first terminal device is damaged and replaced with a new memory, the fingerprint feature information may be downloaded from the server by the control medium, and the fingerprint feature information may be sent to the first terminal device. The user identity authentication can be realized without the first terminal device user re-inputting the fingerprint to form a new fingerprint feature information, thereby improving convenience for the user.

In some embodiments, the fingerprint feature file may be a fingerprint feature file in a first ciphertext form generated by the first terminal device and uploaded to the control medium.

The storage module 1320 may include: a first decryption unit, configured to decrypt the fingerprint feature file in the first ciphertext form by using a private key of the first terminal device to obtain the fingerprint feature file in a plaintext form; a first saving unit, configured to save the fingerprint feature file in the plaintext form.

In some embodiments, the storage module 1320 may further include: a first check unit, configured to check the fingerprint feature file in the plaintext form.

The first saving unit may be configured to save the fingerprint feature file in the plaintext form when the verification of the check unit is passed.

In some embodiments, the first saving unit may include: a first encryption sub-unit, configured to encrypt the fingerprint feature file in the plaintext form by using a private key of the server to obtain the fingerprint feature file in a second ciphertext form; a first saving sub-unit, configured to save the fingerprint feature file in the second ciphertext form.

In some embodiments, if the fingerprint feature information is generated by the first terminal device and uploaded to the control medium, the fingerprint feature file may include the fingerprint feature information in the first ciphertext form and a user identification. The storage module includes: a second decryption unit, configured to decrypt the fingerprint feature information in the first ciphertext form by using the private key of the first terminal device to obtain fingerprint feature information in a plaintext form; and a second saving unit, configured to save a fingerprint feature file including the fingerprint feature information in the plaintext form and the identification of the user.

In some embodiments, the storage module 1332 may further include: a second check unit, configured to check the fingerprint feature information in the plaintext form.

The second saving unit may be configured to save the fingerprint feature file including the fingerprint feature information in the plaintext form and the identification of the user when the verification of the second check unit is passed.

In some embodiments, the second saving unit includes: a second encryption sub-unit, configured to encrypt the fingerprint feature file including the fingerprint feature information in the plaintext form and the identification of the user by using the private key of the server to obtain the fingerprint feature file in the second ciphertext form; a second saving sub-unit, configured to save the fingerprint feature file in the second ciphertext form.

In some embodiments, the download request for downloading the fingerprint feature information carries the identification of the target terminal device, and the transmission module 1330 includes: a determination unit, configured to determine a private key of the target terminal device according to the identifier of the target terminal device when receiving the download request for downloading the fingerprint feature file sent by the control medium; an encryption unit, configured to encrypt the fingerprint feature information in the plaintext form by using the private key of the target terminal device to obtain the fingerprint feature information in a third ciphertext form; a transmission unit, configured to send the fingerprint feature information in the third ciphertext form to the control medium, so that the control medium may send the fingerprint feature information in the third ciphertext form to the target terminal device.

The present disclosure also provides an information processing system, which includes a control medium and a server. The control medium may be configured to send a fingerprint feature file to the server. The fingerprint feature file may include fingerprint feature information and a user identification. The fingerprint feature information or the fingerprint feature file may be generated by a first terminal device and uploaded to the control medium. The control medium may be further configured to send a download request for downloading the fingerprint feature information to the server, and send the fingerprint feature information to a target terminal device after receiving the fingerprint feature information sent by the serve. The target terminal device may be the first terminal device or a second terminal device.

The server may be configured to save the fingerprint feature file after receiving the fingerprint feature file sent by the control medium, and send the fingerprint feature information to the control medium after receiving the download request for downloading the fingerprint feature information sent by the control medium.

According to the information processing system provided in the present disclosure, after the first terminal device generates the fingerprint feature information, the fingerprint feature file containing the fingerprint feature information may be sent to the server by the control medium for storage. Therefore, when the memory for storing the fingerprint feature information on the first terminal device is damaged and replaced with a new memory, the fingerprint feature information may be downloaded from the server by the control medium, and the fingerprint feature information may be sent to the first terminal device. The user identity authentication can be realized without the first terminal device user re-inputting the fingerprint to form a new fingerprint feature information, thereby improving convenience for the user.

The server may include a processor and a memory. The receiving module, the storage module, and the transmission module may be stored in the memory as a program unit, which may be executed by the processor to implement the corresponding functions.

The processor may include one or more kernels which may retrieve the corresponding program unit from the memory. Kernel parameters may be adjusted to improve user convenience.

The memory may include a non-persistent memory, a random access memory (RAM), and/or a non-volatile memory in a computer readable medium. For example, the memory may include a read only memory (ROM) or a flash RAM. The memory may include at least one memory chip.

The present disclosure provides a storage medium on which a program is stored, and the program is implemented by a processor to implement the information processing method.

The present disclosure provides a processor for running a program, wherein the information processing method is executed when the program runs.

The present disclosure provides a device including a processor, a memory, and a program stored on the memory and executable on the processor. The processor may implement the following operations.

An information processing method applied to the server, includes: receiving a fingerprint feature file sent by a control medium, wherein the fingerprint feature file including fingerprint feature information of a user and an identification of the user, the fingerprint feature information or the fingerprint feature file being generated by the first terminal device and then uploaded to the control medium; storing the fingerprint feature file; sending the fingerprint feature information to the control medium when receiving a download request for downloading the fingerprint feature information sent by the control medium, so that the control medium may send the fingerprint feature information to a target terminal device, the target terminal device being the first terminal device or a second terminal device.

Optionally, the fingerprint feature file may be a fingerprint feature file in a first ciphertext form generated by the first terminal device and uploaded to the control medium. The storing the fingerprint feature file includes: decrypting the fingerprint feature file in the first ciphertext form using a private key of the first terminal device to obtain the fingerprint feature file in a plaintext form; and saving the fingerprint feature file in the plaintext form.

Optionally, before saving the fingerprint feature file in the plaintext form, the method further includes: verifying the fingerprint feature file in the plaintext form; and saving the fingerprint feature file in the plaintext form when the verification is passed.

Optionally, the saving the fingerprint feature file in the plaintext form includes: encrypting the fingerprint feature file in the plaintext form using the private key of the server to obtain the fingerprint feature file in a second ciphertext form; and saving the fingerprint feature file in the second ciphertext form.

Optionally, if the fingerprint feature information is generated by the first terminal device and uploaded to the control medium, the fingerprint feature file may include fingerprint feature information in the first ciphertext form and an identification of the user.

The storing the fingerprint feature file includes: decrypting the fingerprint feature information in the first ciphertext form by using the private key of the first terminal device to obtain the fingerprint feature information in a plaintext form; and saving the fingerprint feature file including the fingerprint feature information in the plaintext form and the identification of the user.

Optionally, before saving the fingerprint feature file including the fingerprint feature information and the identification of the user, the method further includes: verifying the fingerprint feature information in the plaintext form, and saving the fingerprint feature file including the fingerprint feature information in the plaintext form and the identification of the user when the verification is passed.

Optionally, the saving the fingerprint feature file including the fingerprint feature information in the plaintext form and the identification of the user includes: encrypting the fingerprint feature file including the fingerprint feature information in the plaintext form and the identification of the user using the private key of the server to obtain the fingerprint feature file in the second ciphertext form; and saving the fingerprint feature file in the second ciphertext form.

Optionally, the download request for downloading the fingerprint feature information carries an identification of the target terminal device, and the sending the fingerprint feature information to the control medium includes: determining a private key of the target terminal device according to the identification of the target terminal device, encrypting the fingerprint feature information in the plaintext form by using the private key of the target terminal device to obtain a fingerprint feature information in a third ciphertext form; sending the fingerprint feature information in the third ciphertext form to the control medium, so that the control medium may send the fingerprint feature information in the third ciphertext form to the target terminal device.

The devices in the present disclosure may be a server, a PC, a PAD, a mobile phone, or the like.

The present disclosure also provides a computer program product adapted to perform a program of the following method operation when executed on a data processing device.

An information processing method applied to a server, including: receiving a fingerprint feature file sent by the control medium, wherein the fingerprint feature file including fingerprint feature information of a user and an identification of the user, the fingerprint feature information or the fingerprint feature file being generated by the first terminal device and then uploaded to the control medium; storing the fingerprint feature file; sending the fingerprint feature information to the control medium when receiving a download request for downloading the fingerprint feature information sent by the control medium, so that the control medium may send the fingerprint feature information to a target terminal device, the target terminal device being the first terminal device or a second terminal device.

Optionally, the fingerprint feature file may be a fingerprint feature file in a first ciphertext form generated by the first terminal device and uploaded to the control medium. The storing the fingerprint feature file includes: decrypting the fingerprint feature file in the first ciphertext form by using a private key of the first terminal device to obtain the fingerprint feature file in a plaintext form; and saving the fingerprint feature file in the plaintext form.

Optionally, before saving the fingerprint feature file in the plaintext form, the method further includes: performing a verification process on the fingerprint feature file in the plaintext form; and saving the fingerprint feature file in the plaintext form when the verification is passed.

Optionally, the saving the fingerprint feature file in the plaintext form includes: encrypting the fingerprint feature file in the plaintext form by using the private key of the server to obtain the fingerprint feature file in a second ciphertext form; and saving the fingerprint feature file in the second ciphertext form.

Optionally, if the fingerprint feature information is generated by the first terminal device and uploaded to the control medium, the fingerprint feature file may include fingerprint feature information in the first ciphertext form and a user identification. The storing the fingerprint feature file includes: decrypting the fingerprint feature information in the first ciphertext form by using the private key of the first terminal device to obtain the fingerprint feature information in a plaintext form; and saving the fingerprint feature file including the fingerprint feature information in the plaintext form and the identification of the user.

Optionally, before saving the fingerprint feature file including the fingerprint feature information and the identification of the user, the method further includes: verifying the fingerprint feature information in the plaintext form, and saving the fingerprint feature file including the fingerprint feature information in the plaintext form and the identification of the user when the verification is passed.

Optionally, the saving the fingerprint feature file including the fingerprint feature information in the plaintext form and the identification of the user includes: encrypting the fingerprint feature file including the fingerprint feature information in the plaintext form and the identification of the user using the private key of the server to obtain the fingerprint feature file in the second ciphertext form; and saving the fingerprint feature file in the second ciphertext form.

Optionally, the download request for downloading the fingerprint feature information carries an identification of the target terminal device, and the sending the fingerprint feature information to the control medium includes: determining a private key of the target terminal device according to the identification of the target terminal device; encrypting the fingerprint feature information in the plaintext form using the private key of the target terminal device to obtain a fingerprint feature information in a third ciphertext form; sending the fingerprint feature information in the third ciphertext form to the control medium, so that the control medium may send the fingerprint feature information in the third ciphertext form to the target terminal device.

FIG. 14 is a flowchart illustrating an exemplary process for an information processing method according to some embodiments of the present disclosure. In some embodiments, the process may be executed by a control medium.

In 1401, the control medium may receive user feature information transmitted by a first terminal device.

The user feature information may be used to verify identity of an operator. The user feature information may be biometric information of the user, including but not limited to, fingerprint information, iris information, palm vein information, facial information, sound information, etc. In some embodiments, the user feature information may include non-biological information of the user, such as a password, motion (e.g., a gesture of the user), etc. In some embodiments, the user feature information may further include a predetermined code set by the administrator of the first terminal device. An unauthorized user may gain access to the first terminal device (e.g., access to operate the first terminal device) by inputting the predetermined code. A first terminal device may acquire the user feature information. In some embodiments, the first terminal device may further obtain an identification of the user corresponding to the user feature information. The first terminal device may transmit the identification of the user to the control medium.

In 1402, the control medium may send the user feature information to a server. In some embodiments, the control medium may send the user feature information and the identification of the user to the server at the same time. The user feature information and the identification of the user may be combined into a user feature file. In some embodiments, the control medium may send the user feature information after encrypting it.

In 1403, the control medium may send a download request for downloading the user feature information to the server. In some embodiments, an operator may initiate the download request using a terminal device (e.g., the user terminal 140). The download request may be transmitted from the terminal device to the control medium. In some embodiments, the download request may carry the identification of the user, so that the server may retrieve the user feature information corresponding to the identification of the user. In some embodiments, the download request may carry an identification of a target terminal for identifying a terminal that needs to download the user feature information.

In 1404, the control medium may receive the user feature information sent by the server in response to the download request. In some embodiments, the server may retrieve the corresponding user feature information according to the identification of the user and then send the information. In some embodiments, the server may determine whether the control medium and/or the target terminal is/are authenticated to download the user feature information. If the control medium and/or the target terminal is/are authenticated, the server may send the user feature information.

In 1405, the control medium may send the user feature information to a target terminal. The target terminal may be a smart device (e.g., the smart device 130) or a user terminal (e.g., the user terminal 140). The target terminal and the first terminal device may be the same terminal, or different terminals.

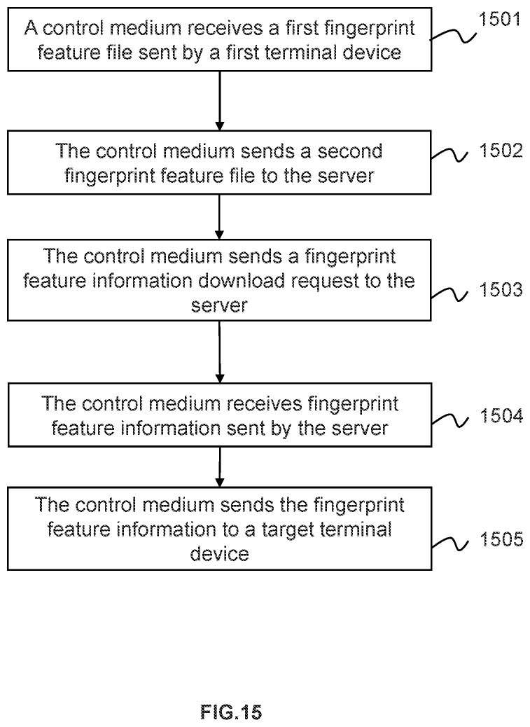

FIGS. 15 to 18 illustrate the methods and systems for information management by taking fingerprint feature information as an example according to some embodiments of the present disclosure. It should be understood that the present disclosure is not limited to fingerprint feature information, but may also be used for other feature information, such as iris information, palm vein information, facial information, sound information, etc., and may even be used for non-biological features, such as ordinary password information like digital passwords, motion information (e.g., a gesture of the user), etc.

FIG. 15 is a flowchart illustrating an exemplary process for processing information by the control medium according to some embodiments of the present disclosure.

In 1501, a fingerprint feature file transmitted by the first terminal device may be received by the control medium. The fingerprint feature file may include at least fingerprint feature information of a user.

The first terminal device may send the first fingerprint feature file to the control medium. The fingerprint feature file may include at least fingerprint feature information of the user.

In some embodiments, the first terminal device may collect the user's fingerprint. The first terminal device may generate fingerprint feature information based on the collected fingerprint. The first terminal device may transmit the fingerprint feature information to the control medium. That is to say, the identification of the user is not included in the first fingerprint feature file. In some embodiments, the first terminal device may collect the user's fingerprint. The first terminal device may generate fingerprint feature information based on the collected fingerprint. The first terminal device may transmit the fingerprint feature file including the fingerprint feature information and the identification of the user to the control medium. That is to say, the first fingerprint feature file includes both the fingerprint feature information and the identification of the user. In some embodiments, the first terminal device may collect the user's fingerprint in response to a fingerprint input instruction after receiving the fingerprint input instruction transmitted by the control medium. The first terminal device may generate fingerprint feature information based on the collected fingerprint. The first terminal device may transmit the fingerprint feature information to the control medium. That is to say, the identification of the user is not included in the first fingerprint feature file. In some embodiments, the first terminal device may collect user fingerprint in response to a fingerprint input instruction after receiving the fingerprint input instruction transmitted by the control medium. The first terminal device may generate fingerprint feature information based on the collected fingerprint. The first terminal device may transmit a fingerprint feature file including the fingerprint feature information and the identification of the user to the control medium. That is to say, the first fingerprint feature file includes both the fingerprint feature information and the identification of the user.

While the first terminal device transmits the first fingerprint feature file to the control medium, it may also store the fingerprint feature information locally, so that the first terminal device may authenticate user identity by using the locally stored fingerprint feature information.

In some embodiments, the first terminal device may transmit only the fingerprint feature information to the control medium. Alternatively, the first terminal device may transmit both the fingerprint feature information and the identification of the user to the control medium. For example, if the first terminal device cannot obtain the identification of the user, the first terminal device may transmit only the fingerprint feature information to the control medium. If the first terminal device can obtain the identification of the user, the first terminal device may transmit both the fingerprint feature information and the identification of the user to the control medium. As another example, even if the first terminal device can obtain the identification of the user, the first terminal device may transmit only the fingerprint feature information to the control medium.

The control medium may refer to a software and/or device that can communicate with the first terminal device. For example, the control medium may be a host computer, a mobile phone, a gateway, etc. As another example, the control medium may be an application installed in an electronic device. The first terminal device may be an electronic device such as a mobile phone, a door lock, a fingerprint input device, an access control device, etc.

The control medium and the first terminal device may transmit data through a channel having a low data transmission rate such as a Bluetooth, a ZigBee, etc. Alternatively, the control medium and the first terminal device may transmit data through a channel having a high data transmission rate such as a WiFi.

If the control medium communicates with the first terminal device through a channel having a low data transmission rate, the first terminal device may split the first fingerprint feature file transmitted to the control medium into a plurality of data packets with a fixed length. The first terminal device may transmit the plurality of data packets to the control medium one by one.

In 1502, a second fingerprint feature file may be transmitted by the control medium to the server. The second fingerprint feature file may include the identification of the user and the user fingerprint feature information. The server may save the second fingerprint feature file.

In the case that the first terminal device does not transmit the fingerprint identification to the control medium, the identification of the user may be obtain by the control medium. For example, the control medium may receive a user identification input by the user. As another example, the control medium may acquire identification information of the user (e.g., reading the ID card information, collecting a user image, etc.) by using an acquisition device.

After receiving the first fingerprint feature file transmitted by the first terminal device, the control medium may automatically send the second fingerprint feature file to the server, or may send the second fingerprint feature file to the server after receiving a transmission instruction initiated by the user.

If the first fingerprint feature file includes both the fingerprint feature information and the identification of the user, the control medium may directly forward the first fingerprint feature file to the server after receiving the first fingerprint feature file transmitted by the first terminal device. Alternatively, the control medium may firstly perform a simple verification process on the first fingerprint feature file after receiving the first fingerprint feature file transmitted by the first terminal device. For example, the control medium may determine whether a total data length of the first fingerprint feature file is the same as a total data length reported by the first terminal device. If the total data lengths are the same, the verification is passed, otherwise the verification fails. The control medium may forward the first fingerprint feature file to the server only when the verification is passed. Otherwise, the first fingerprint feature file may be prohibited from being forwarded to the server. In other words, when the first fingerprint feature file includes both the fingerprint feature information and the identification of the user, the second fingerprint feature file is the first fingerprint feature file.

If the first fingerprint feature file does not include the identification of the user, the control medium may directly forward the first fingerprint feature file and a second fingerprint feature file including the locally obtained user identification to the server after receiving the first fingerprint feature file transmitted by the first terminal device. Alternatively, the control medium may firstly perform a simple verification process on the first fingerprint feature file after receiving the first fingerprint feature file transmitted by the first terminal device. For example, the control medium may determine whether a total data length of the first fingerprint feature file is the same as a total data length reported by the first terminal device. If the total data lengths are the same, the verification is passed, otherwise the verification is fails. The control medium may forward the second fingerprint feature file to the server only when the verification is passed. Otherwise, the second fingerprint feature file may be prohibited from being forwarded to the server.

After receiving the second fingerprint feature file, the server may store the second fingerprint feature file in a plaintext form, or may store the second fingerprint feature file in a ciphertext form.

In 1503, a download request for downloading the fingerprint feature information may be sent by the control medium to the server. The download request for downloading the fingerprint feature information may carry a user identification.

The download request for downloading the fingerprint feature information sent by the control medium to the server may be triggered by a user operating on the control medium.

The download request for downloading the fingerprint feature information sent by the control medium to the server may be triggered by a user operating on the first terminal device and sent to the control medium, or may be triggered by the user operating on the second terminal device and sent to the control medium. That is, the control medium may forward the download request for downloading the fingerprint feature information sent by the first terminal device or the second terminal device to the server.

In 1504, the fingerprint feature information sent by the server may be received by the control medium.

In response to the download request for downloading the fingerprint feature information, the server may send the fingerprint feature information corresponding to the identification of the user to the control medium.

The fingerprint feature information corresponding to the identification of the user may be the fingerprint feature information contained in the second fingerprint feature file containing the identification of the user.

In some embodiments, in the case that the download request for downloading the fingerprint feature information is generated and transmitted by the control medium, after receiving the download request for downloading the fingerprint feature information and before sending the fingerprint feature information to the control medium, the server may first determine whether the control medium is authenticated to download the fingerprint feature information. If the control medium is authenticated to download the fingerprint feature information, the server may send the fingerprint feature information to the control medium. Otherwise, the fingerprint feature information may be prohibited from being sent to the control medium.

Further, in addition to determining whether the control medium is authenticated to download the fingerprint feature information, the server may also determine whether the terminal device (i.e., the terminal device corresponding to the identification carried in the download request for downloading the fingerprint feature information) is authenticated to download the fingerprint feature information. In other words, the server may send the fingerprint feature information to the control medium only when the terminal device and the control medium are authenticated to download the fingerprint feature information. Otherwise, the fingerprint feature information may be prohibited from being sent to the control medium.

Determining whether the control medium is authenticated to download the fingerprint feature information may be implemented as the following operations.

The server may determine whether the identification of the control medium carried in the download request for downloading the fingerprint feature information is a predetermined first identification.

If the result of the determination is yes, it may be determined that the control medium is authenticated to download the fingerprint feature information. Otherwise, it may be determined that the control medium is not authenticated to download the fingerprint feature information.

Determining whether the terminal device is authenticated to download the fingerprint feature information may be implemented as the following operations.

The server may determine whether the identification of the terminal device carried in the download request for downloading the fingerprint feature information is a predetermined second identification.

If the result of the determination is yes, it may be determined that the terminal device is authenticated to download the fingerprint feature information. Otherwise, it may be determined that the terminal device is not authenticated to download the fingerprint feature information.

In some embodiments, in the case that the download request for downloading the fingerprint feature information is generated and transmitted by the terminal device, after receiving the download request for downloading the fingerprint feature information and before sending the fingerprint feature information to the control medium, the server may first determine whether the terminal device is authenticated to download the fingerprint feature information. If the terminal device is authenticated to download the fingerprint feature information, the server may send the fingerprint feature information to the control medium. Otherwise, the fingerprint feature information may be prohibited from being sent to the control medium.

Further, in addition to determining whether the terminal device is authenticated to download the fingerprint feature information, the server may also determine whether the control medium is authenticated to download the fingerprint feature information. In other words, the server may send the fingerprint feature information to the control medium only when the terminal device and the control medium are authenticated to download the fingerprint feature information. Otherwise, the fingerprint feature information may be prohibited from being sent to the control medium.

In 1505, the fingerprint feature information may be sent by the control medium to the target terminal device. The target terminal device may be the first terminal device or the second terminal device.

The second terminal device may be an electronic device such as a mobile phone, a door lock, an access control device, etc. Both the first terminal device and the second terminal device may have a fingerprint collection and fingerprint authentication function. The first terminal device and the second terminal device may be different electronic devices.

According to some embodiments of the present disclosure, when the first terminal device needs to use the fingerprint feature information (for the sake of description, it is recorded as the first fingerprint feature information) for user identity authentication while the first terminal device does not store the first fingerprint feature information locally (e.g., when the memory for storing the first fingerprint feature information in the first terminal device is replaced, or when the first terminal device is restored to the factory settings, etc.), the first fingerprint feature information may be downloaded from the server by the control medium, and the first fingerprint feature information may be sent to the first terminal device.

When the second terminal device needs to use the first fingerprint feature information for user identity authentication, the first fingerprint feature information may be downloaded from the server by the control medium, and the first fingerprint feature information may be sent to the second terminal device.

According to the information processing method provided in the present disclosure, after the first terminal device generates the fingerprint feature information, the fingerprint feature file containing the fingerprint feature information may be sent to the server by the control medium for storage. Therefore, when the memory for storing the fingerprint feature information on the first terminal device is damaged and replaced with a new memory, the fingerprint feature information may be downloaded from the server by the control medium, and the fingerprint feature information may be sent to the first terminal device. The user identity authentication can be realized without the first terminal device user re-inputting the fingerprint to form a new fingerprint feature information, thereby improving user convenience.

Similarly, when the second terminal device needs to use the first fingerprint feature information for user identity authentication, the first fingerprint feature information may be downloaded from the server by the control medium, and the first fingerprint feature information may be sent to the second terminal device. There is no need to input a fingerprint multiple times in the second terminal device to generate new fingerprint feature information, thereby improving convenience for the user.

In addition, a communication connection between the server and the terminal device may be established by the control medium. A low-speed data transmission may be performed between the control medium and the terminal device, and a high-speed data transmission may be performed between the control medium and the server via a high-speed network. On one hand, the information processing method provided by the present disclosure may be applied as long as the low-speed data transmission between the terminal device and the control medium can be performed, the configuration of the terminal device may be relatively low, thereby reducing the cost of the terminal device. On the other hand, in some application scenarios (e.g., in a hotel of which the frequency of updating the fingerprint feature information of the door lock is relatively high) where fingerprint feature information is updated frequently, the administrator may manage the collection, storage, and distribution of the fingerprint feature information through the control medium (e.g., the computer at the front desk), which is convenient for the administrator to operate.

In addition, after receiving the download request for downloading the fingerprint feature information, the server may not directly send the fingerprint feature information to the control medium, but send the fingerprint feature information to the control medium after determining that the control medium and/or the terminal device is/are authenticated to download. Otherwise, the fingerprint feature information may be not sent to the control medium, which further improves the security of the fingerprint feature information.

In some embodiments, that the control medium receives the first fingerprint feature file sent by the first terminal device may be implemented in the following manner. The control medium may receive the first fingerprint feature file in the first ciphertext sent by the first terminal device.

In some embodiments, the first terminal device may send the first fingerprint feature file to the control medium in ciphertext.

If the first terminal device splits the fingerprint feature file into multiple data packets and then uploads them to the control medium, the first terminal device may encrypt each data packet and uploads it to the control medium.

The first terminal device may encrypt the first fingerprint feature file using the private key of the first terminal device to obtain a first fingerprint feature file in the first ciphertext form.

In some embodiments, if the first fingerprint feature file further includes the identification of the user, that the control medium may send the second fingerprint feature file to the server may be implemented as following operations. The identification of the first terminal device and the first fingerprint feature file in the first ciphertext form may be sent by the control medium to the server as the second fingerprint feature file. Since the technique for obtaining the identification of the first terminal device by the control medium is already mature, it will not be described in detail in the present disclosure.

In some embodiments, if the identification of the user is not included in the first fingerprint feature file, that the control medium may send the second fingerprint feature file to the server may be implemented as following operations. The identification of the first terminal device, the obtained user identification, and the first fingerprint feature file in the first ciphertext form may be sent to the server as the second fingerprint feature file.

The server may store a decryption algorithm corresponding to an encryption algorithm that the first terminal device performs an encryption using the private key of the first terminal device. After receiving the second fingerprint feature file, the server may determine the private key corresponding to the identification of the first terminal device by using the identification of the first terminal device and the correspondence between pre-stored device identification(s) and private key(s). The first fingerprint feature file in the second fingerprint feature file or the second fingerprint feature file may be decrypted by using the private key to obtain a second fingerprint feature file in plaintext form or a first fingerprint feature file in plaintext form.

The server may save the second fingerprint feature file in the plaintext form obtained by decryption. Alternatively, the server may save the fingerprint feature file composed of the first fingerprint feature file in the plaintext form and the identification of the user.

It should be noted that, in this embodiment, that the server may save fingerprint feature file in the plaintext form does not specifically refer to that the server may save, in the plaintext form, the fingerprint feature file in the plaintext form, but refers to save the fingerprint feature file obtained by the decryption. Specifically, when the fingerprint feature file obtained by the decryption is saved, the fingerprint feature file obtained by decryption may be saved in the plaintext form, or a ciphertext form.

In the process for saving the fingerprint feature file in the plaintext form, if the fingerprint feature file is saved in the plaintext form, the fingerprint feature file in the plaintext form may be encrypted into the fingerprint feature file in a second ciphertext form, and the fingerprint feature file in the second ciphertext form may be saved. That is, the fingerprint feature file is saved in the second ciphertext form. Private key used to obtain the fingerprint feature file in the first ciphertext form is different from the private key used to obtain the fingerprint feature file in the second ciphertext form. The encryption algorithm used to obtain the fingerprint feature file in the second ciphertext form and the fingerprint feature file in the first ciphertext form may be the same or different.

In the embodiment of the present disclosure, in the process that the first terminal device sends the first fingerprint feature file to the control medium, the first fingerprint feature file is encrypted by using the private key of the first terminal device. Therefore, it avoids the security problem that after the control medium is cracked by a third-party and the received first fingerprint feature file is separately and maliciously saved in and applied to other terminal devices.

In some embodiments, the download request for downloading the fingerprint feature information sent by the control medium to the server also carries the identification of the target terminal device. The identification of the target terminal device may be manually input by the user, or may be selected by the user from a list device identifications provided by the control medium.

The fingerprint feature information corresponding to the identification of the user sent by the server to the control medium may be the fingerprint feature information in the third ciphertext form. The private key of the target terminal device may be determined by the server according to the identification of the target terminal device and the correspondence between the preset device identification(s) and the private key(s), and the fingerprint feature information in the third ciphertext form may be determined by encrypting the fingerprint feature information by using the private key of the target terminal device.

The encryption algorithm used by the server to encrypt the fingerprint feature file using the private key of the target terminal device may be the same as or different from the encryption algorithm used by the first terminal device to encrypt the first fingerprint feature file using the private key of the first terminal device. That is to say, the fingerprint feature information in the third ciphertext form may be the fingerprint feature information in the first ciphertext form, or may not be the fingerprint feature information in the first ciphertext form.

The target terminal device may store a decryption algorithm corresponding to an encryption algorithm which is used by the server to encrypt the fingerprint feature file using the private key of the target terminal device.

After receiving the fingerprint feature information in the third ciphertext form sent by the control medium, the target terminal device may decrypt the fingerprint feature information in the third ciphertext form by using the private key of the target terminal device to obtain the fingerprint feature information in the plaintext form.

In some embodiments, the first fingerprint feature file may also include: first verification information of the user fingerprint feature information, so that the server may verify the user fingerprint feature information according to the first verification information before saving the second fingerprint feature file, and save the second fingerprint feature file when the verification is passed.

If the second fingerprint feature file received by the server is the second fingerprint feature file in the plaintext form, the fingerprint feature information in the second fingerprint feature file may be directly verified according to the first verification information. If the second fingerprint feature file received by the server is the second fingerprint feature file in the ciphertext form, or the first fingerprint feature file in the second fingerprint feature file is the first fingerprint feature file in the ciphertext form, the server may first decrypt the second fingerprint feature file or the first fingerprint feature file. Then, the first verification information may be used to verify the fingerprint feature information in the decrypted second fingerprint feature file in the plaintext form or the first fingerprint feature file in the plaintext form. That is to say, the first verification information is calculated according to the fingerprint feature information in the plaintext form.

In the process for saving the second fingerprint feature file in the plaintext form, the server may verify the fingerprint feature information in the second fingerprint feature file in the plaintext form first before saving the second fingerprint feature file in the plaintext form. The second fingerprint feature file in the plaintext form may be saved when the verification is passed, otherwise, the fingerprint feature file in the plaintext form may be not saved, thereby ensuring the integrity and validity of the stored fingerprint feature file.

In the process for saving the second fingerprint feature file in the plaintext form, the second fingerprint feature file may be saved directly in the plaintext form or may be saved in a ciphertext form.

When the second fingerprint feature file is saved in the ciphertext form, the second fingerprint feature file may be encrypted using the private key of the server.

In some embodiments, after the control medium sends the fingerprint feature information download request to the server, the method further includes: receiving a second verification information of the fingerprint feature information corresponding to the identification of the user sent by the server.

After receiving the fingerprint feature information download request, the server may calculate the verification information of the fingerprint feature information corresponding to the identification of the user, which is recorded as the second verification information. While transmitting the fingerprint feature information corresponding to the identification of the user to the control medium, the second verification information of the fingerprint feature information may be also sent to the control medium.

While transmitting the fingerprint feature information to the target terminal device by the control medium, the second verification information of the fingerprint feature information may be also sent to the target terminal device, so that the target terminal may verify the received fingerprint feature information by using the second verification information after receiving the fingerprint feature information.

Generally, the second verification information may be fingerprint information obtained by calculating the fingerprint feature information in the plaintext form. After the target terminal device receives the fingerprint feature information, if the fingerprint feature information is in a plaintext form, the fingerprint feature information may be directly verified by using the second verification information. If the fingerprint feature information is in a ciphertext form, the fingerprint feature information may be decrypted first, and then the fingerprint feature information obtained by the decryption may be verified by using the second verification information.

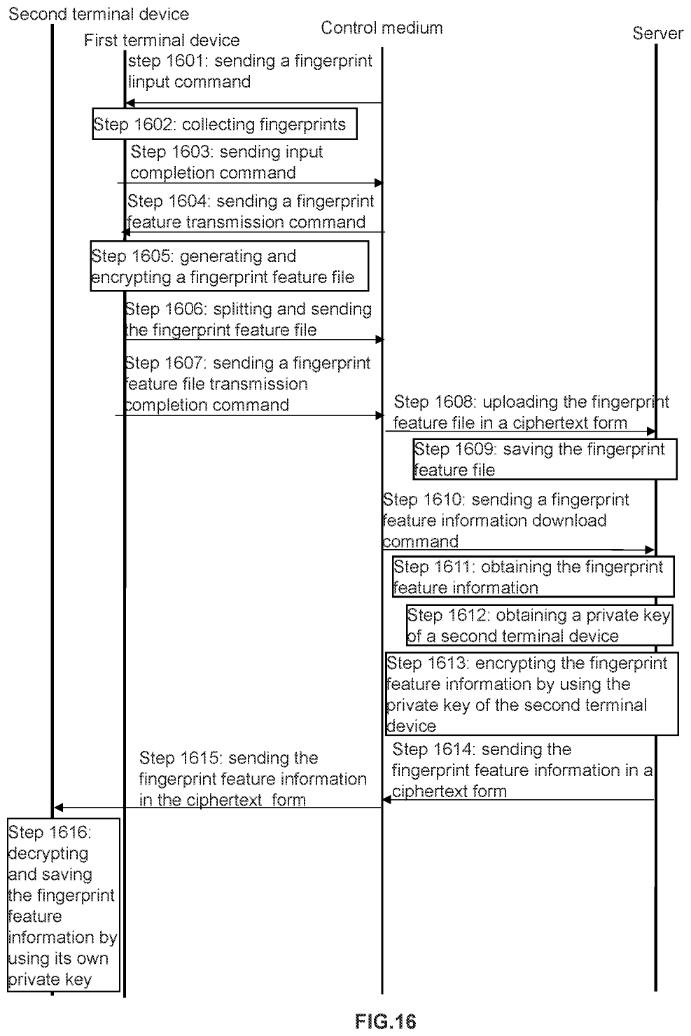

FIG. 16 is a flowchart illustrating an exemplary process for processing information by a control medium according to some embodiments of the present disclosure.

In 1601, a fingerprint input command may be sent by the control medium to a first terminal device.

The fingerprint input command may be triggered by a control medium user operating on the control medium.

In 1602, in response to the fingerprint input command, the first terminal device may initiate a fingerprint input process to collect a fingerprint. User A may press a fingerprint sensor of the first terminal device by using the same finger multiple times according to an operation prompt. A fingerprint processing chip of the first terminal device may perform a feature extraction on the fingerprint collected by the fingerprint sensor to obtain fingerprint feature information of the user A.

In 1603, an input completion command may be sent by the first terminal device to the control medium.

In 1604, a fingerprint feature file transmission command may be sent by the control medium to the first terminal device.

The fingerprint feature file transmission command may be triggered by the control medium user operating on the control medium, or may be automatically generated after the control medium receives an input completion command.

In 1605, in response to the fingerprint feature file transmission command, a fingerprint feature file may be generated and encrypted by the first terminal device.

The fingerprint feature file may include the fingerprint feature information of the user A and the identification of the user A (for the sake of description, it is recorded as the first user identification). The first user identification may be manually input by the user to the first terminal device, or automatically collected by the first terminal device.

The first terminal device may encrypt the fingerprint feature file using its own private key.

Alternatively, before encrypting the fingerprint feature file, a check value of the fingerprint feature file, such as a CRC check value, may be calculated. After calculating the check value, the fingerprint feature file may be encrypted.

In 1606, the fingerprint feature file in a ciphertext form may be split into a plurality of data packets and may be sent by the first terminal device to the control medium.

Alternatively, if the check value is calculated, the first terminal device may also send the check value to the control medium. The check value may be included in a data packet and sent to the control medium, or sent to the control medium as a separate data packet.

In 1607, a fingerprint feature file transmission completion command may be sent by the first terminal device to the control medium after all the data packets are sent to the control medium.

In 1608, the fingerprint feature file in the ciphertext form may be sent by the control medium to the server after receiving the fingerprint feature file transmission completion command.

In 1609, after receiving the fingerprint feature file in the ciphertext form, the server may decrypt the fingerprint feature file in the ciphertext form by using a private key of the first terminal device and save the decrypted fingerprint feature file.

Alternatively, if the control medium also transmits the check value, a verification process may first be performed on the fingerprint feature file obtained by the decryption by using the check value after the server decrypts the fingerprint feature file. The fingerprint feature file may be saved when the verification is passed.

When the server saves the decrypted fingerprint feature file, the fingerprint feature information may be saved in plaintext or ciphertext. While the fingerprint feature file is saved in ciphertext, the fingerprint feature information in the fingerprint feature file in the plaintext form may be encrypted by using the private key of the server.

The encrypted fingerprint feature information may be saved in association with the identification of the user.

The above operations are a specific implementation process for uploading the fingerprint input and fingerprint feature file. The process for sending the fingerprint feature information may be described below.

In 1610, a fingerprint feature information download command may be sent by the control medium to the server. The fingerprint feature information download command may include the first user identification (i.e., the identification of the user A) and an identification of the first terminal device.

In 1611, a corresponding fingerprint feature information (i.e., the user A's fingerprint feature information) may be obtained by the server according to the first user identification after receiving the fingerprint feature information download command. If the obtained fingerprint feature information is in the ciphertext form, the fingerprint feature information in the ciphertext form may be decrypted by using the private key of the server to obtain the fingerprint feature information in the plaintext form.

In 1612, the private key of the first terminal device may be acquired by the server using the identification of the first terminal device.

In 1613, the fingerprint feature information in the plaintext form may be encrypted by the server using the private key of the first terminal device.

Optionally, before encrypting the fingerprint feature information in the plaintext form, the check value of the fingerprint feature information in the plaintext form may be calculated, and then the fingerprint feature information in the plaintext form may be encrypted.

In 1614, the fingerprint feature information in the ciphertext form may be sent by the server to the control medium.

Optionally, if the server also calculates the check value, the check value may be sent to the control medium together.

In 1615, the fingerprint feature information in the ciphertext form may be split into a plurality of data packets and may be sent by the control medium to the first terminal device.

In 1616, the fingerprint feature information in the ciphertext form may be decrypted by the first terminal device using its own private key. The fingerprint feature information in the ciphertext form may be saved by the first terminal device then.

Optionally, if the server further sends the check value, the first terminal device may perform a verification on the fingerprint feature information obtained by the decryption using the check value.

Operations 1610 to 1616 illustrates the process in which the control medium downloads the fingerprint feature information of the user A required by first terminal device from the server. The process in which the control medium downloads the fingerprint feature information of the user A required by the second terminal device from the server may be described below.

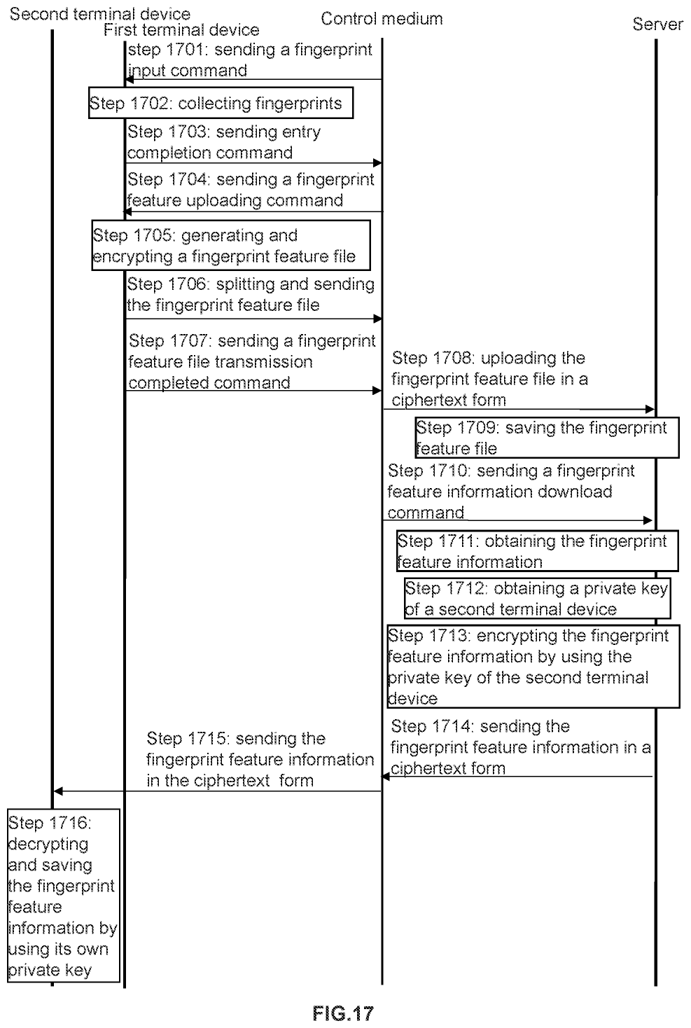

FIG. 17 is a flowchart illustrating an exemplary process for processing information by a control medium according to some embodiments of the present disclosure.

In 1701, a fingerprint input command may be sent by the control medium to a first terminal device.

In 1702, in response to the fingerprint input command, the first terminal device may initiate a fingerprint input process to collect a fingerprint.

In 1703, an input completion command may be sent by the first terminal device to the control medium.

In 1704, a fingerprint feature file transmission command may be sent by the control medium to the first terminal device.

In 1705, in response to the fingerprint feature file transmission command, a fingerprint feature file may be generated and encrypted by the first terminal device. The fingerprint feature file may include the fingerprint feature information of the user A and the identification of the user A (for the sake of description, it is recorded as the first user identification). The first user identification may be manually input by the user to the first terminal device, or automatically collected by the first terminal device.

In 1706, the fingerprint feature file in a ciphertext form may be split into a plurality of data packets and may be sent by the first terminal device to the control medium.

In 1707, a fingerprint feature file transmission completion command may be sent by the first terminal device to the control medium after all the data packets are sent to the control medium.

In 1708, the fingerprint feature file in the ciphertext form may be sent by the control medium to the server after receiving the fingerprint feature file transmission completion command.

In 1709, after receiving the fingerprint feature file in the ciphertext form, the server may decrypt the fingerprint feature file in the ciphertext form and save the decrypted fingerprint feature file.

More descriptions about the implementation process of operations 1701 to 1709 may be found in connection with operations 1601 to 1609.

In 1710, a fingerprint feature information download command may be sent by the control medium to the server. The fingerprint feature information download command may include the first user identification (i.e., the identification of the user A) and an identification of a second terminal device.

In 1711, a corresponding fingerprint feature information (i.e., the user A's fingerprint feature information) may be obtained by the server according to the first user identification after receiving the fingerprint feature information download command.

In 1712, a private key of the second terminal device may be acquired by the server using the identification of the second terminal device.

In 1713, the fingerprint feature information in the plaintext form may be encrypted by the server using the private key of the second terminal device.

Optionally, before encrypting the fingerprint feature information in the plaintext form, the check value of the fingerprint feature information in the plaintext form may be calculated, and then the fingerprint feature information in the plaintext form may be encrypted.

In 1714, the fingerprint feature information in the ciphertext form may be sent by the server to the control medium.

Optionally, if the server also calculates the check value, the check value may be sent to the control medium together.

In 1715, the fingerprint feature information in the ciphertext form may be split into a plurality of data packets and may be sent by the control medium to the second terminal device.

In 1716, the fingerprint feature information in the ciphertext form may be described by the second terminal device using its own private key. The fingerprint feature information in the ciphertext form may be saved by the second terminal device then.

Optionally, if the server further sends the check value, the second terminal device may perform a verification process on the fingerprint feature information obtained by the decryption using the check value.

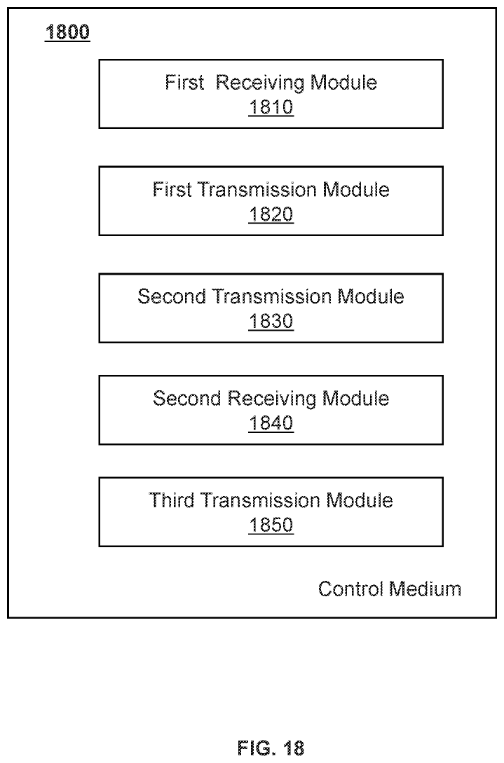

FIG. 18 is a block diagram illustrating an exemplary control medium for processing information according to some embodiments of the present disclosure. As shown in FIG. 18, the control medium may include a first receiving module 1810, a first transmission module 1820, a second transmission module 1830, a second receiving module 1840, and a third transmission module 1850.

The first receiving module 1810 may be configured to receive a first fingerprint feature file sent by a first terminal device. The first fingerprint feature file may include at least fingerprint feature information of a user.

The first transmission module 1820 may be configured to send a second fingerprint feature file to the server. The second fingerprint feature file may include an identification of the user and fingerprint feature information of the user. The server may save the second fingerprint feature file.

The second transmission module 1830 may be configured to send a fingerprint feature information download request to the server. The fingerprint feature information download request may include the identification of the user.

The second receiving module 1840 may be configured to receive fingerprint feature information corresponding to the identification of the user sent by the server.

The third transmission module 1850 may be configured to send the fingerprint feature information to a target terminal device. The target terminal device may be the first terminal device or a second terminal device.

According to the control medium provided in the present disclosure, after the first terminal device generates the fingerprint feature information, the fingerprint feature file containing the fingerprint feature information may be sent to the server by the control medium for storage. Therefore, when the memory for storing the fingerprint feature information on the first terminal device is damaged and replaced with a new memory, the fingerprint feature information may be downloaded from the server by the control medium, and the fingerprint feature information may be sent to the first terminal device. The user identity authentication can be realized without the first terminal device user re-inputting the fingerprint to form a new fingerprint feature information, thereby improving user convenience.

In some embodiments, the first receiving module 1810 may be configured to receive the first fingerprint feature file in a first ciphertext form sent by the first terminal device.

In some embodiments, the first fingerprint feature file may further include the identification of the user. The first transmission module 1820 may be specifically configured to send an identification of the first terminal device and the first fingerprint feature file in the first ciphertext form to the server as the second fingerprint feature file.

In some embodiments, the identification of the user may be not included in the first fingerprint feature file. The first transmission module 1820 may be specifically configured to send the identification of the first terminal device, the acquired identification of the user, and the first fingerprint feature file in the first ciphertext form to the server as the second fingerprint feature file.

In some embodiments, the fingerprint feature information download request may further include an identification of the target terminal device. The second receiving module 1840 may be specifically configured to receive fingerprint feature information in a third ciphertext form sent by the server. The fingerprint feature information in the third ciphertext form may be obtained by the server encrypting the fingerprint feature information corresponding to the identification of the user by using a private key corresponding to the identification of the target terminal device.

In some embodiments, the first receiving module 1810 may be configured to receive a plurality of data packets sent by the first terminal device. The plurality of data packets may be obtained by splitting the first fingerprint feature file.

In some embodiments, the first fingerprint feature file may further include a first verification information of the user fingerprint feature information. After receiving the second fingerprint feature file, the server may perform a verification process on the user fingerprint feature information based on the first verification information. If the verification is passed, the second fingerprint feature file may be saved.

In some embodiments, the second receiving module 1840 may further be configured to receive a second verification information of the fingerprint feature information corresponding to the identification of the user sent by the server.

The third transmission module 1850 may further be configured to send the second verification information of the fingerprint feature information to the target terminal device. The target terminal device may perform a verification on the received fingerprint feature information using the second verification information after receiving the fingerprint feature information.

The present disclosure also provides an information processing system including a control medium, a first terminal device, and at least one second terminal device.

The first terminal device may be configured to collect a fingerprint of a user to generate fingerprint feature information. The first terminal device may further be configured to send a first fingerprint feature file including at least the fingerprint feature information to the control medium. The first terminal device may further be configured to receive fingerprint feature information corresponding to a user identification of the user sent by the control medium.

The control medium may be configured to receive the first fingerprint feature file. The control medium may further be configured to send a second fingerprint feature file to the server. The second fingerprint feature file may include the identification of the user and the fingerprint feature information of the user. The server may save the second fingerprint feature file. The control medium may further be configured to send a fingerprint feature information download request to the server. The fingerprint feature information download request may include the identification of the user. The control medium may further be configured to receive fingerprint feature information corresponding to the identification of the user sent by the server. The control medium may further be configured to send the fingerprint feature information to a target terminal device. The target terminal device may be the first terminal device and/or the second terminal device.

The second terminal device may be configured to receive the fingerprint feature information corresponding to the identification of the user sent by the control medium.

The control medium may include a processor and a memory. The first receiving module 1810, the first transmission module 1820, the second transmission module 1830, the second receiving module 1840 and the third transmission module 1850, etc. may be stored in the memory as program units, which may be executed by the processor to implement the corresponding functions.

The processor may include one or more kernels which may retrieve the corresponding program unit from the memory. Kernel parameters may be adjusted to improve user convenience.

The memory may include a non-persistent memory, a random access memory (RAM), and/or a non-volatile memory in a computer readable medium. For example, the memory may include a read only memory (ROM) or a flash RAM. The memory may include at least one memory chip.

The present disclosure provides a storage medium on which a program may be stored, and when the program is executed by a processor, the information processing method may be implemented.

The present disclosure provides a processor for executing a program, when the program is executed, the information processing method may be implemented.

The present disclosure provides a device including a processor, a memory, and a program stored on the memory and executed by the processor. Following operations may be implemented by the processor.

An information processing method applied to a control medium, including: receiving a first fingerprint feature file sent by a first terminal device, the first fingerprint feature file including at least fingerprint feature information of a user; sending a second fingerprint feature file to a server, the second fingerprint feature file including an identification of the user and the fingerprint feature information of the user to enable the server to save the second fingerprint feature file; sending a fingerprint feature information download request to the server, the fingerprint feature information download request including the identification of the user; receiving, by the server, fingerprint feature information corresponding to the identification of the user; sending the fingerprint feature information corresponding to the identification of the user to a target terminal device, the target terminal device being the first terminal device or a second terminal device.

Preferably, the receiving the first fingerprint feature file sent by the first terminal device includes: receiving, by the first terminal device, the first fingerprint feature file in a first ciphertext form.

Preferably, the first fingerprint feature file may further include the identification of the user. The sending the second fingerprint feature file to the server includes: sending an identification of the first terminal device and the first fingerprint feature file in the first ciphertext form to the server as the second fingerprint feature file. Alternatively, the identification of the user may be not included in the first fingerprint feature file. The sending the second fingerprint feature file to the server includes: sending the identification of the first terminal device, the acquired user identification, and the first fingerprint feature file in the first ciphertext form to the server as the second fingerprint feature file.

Preferably, the fingerprint feature information download request may further include an identification of the target terminal device.

The receiving the fingerprint feature information corresponding to the identification of the user sent by the server includes: receiving the fingerprint feature information in a third ciphertext form sent by the server. The fingerprint feature information in the third ciphertext form may be obtained by the server encrypting the fingerprint feature information corresponding to the identification of the user by using a private key corresponding to the identification of the target terminal device.

Preferably, the receiving the first fingerprint feature file sent by the first terminal device includes: receiving a plurality of data packets sent by the first terminal device. The plurality of data packets may be obtained by splitting the first fingerprint feature file.

Preferably, the first fingerprint feature file may further include a first verification information of the user fingerprint feature information. Before saving the second fingerprint feature file, the server may perform a verification process on the user fingerprint feature information based on the first verification information. If the verification is passed, the second fingerprint feature file may be saved.

Preferably, after sending the fingerprint feature information download request to the server, the method further includes: receiving a second verification information of the fingerprint feature information corresponding to the identification of the user sent by the server; sending the second verification information of the fingerprint feature information to the target terminal device. The target terminal device may perform a verification on the received fingerprint feature information using the second verification information after receiving the fingerprint feature information.

The devices in the present disclosure may be a server, a PC, a PAD, a mobile phone, etc.

The present disclosure also provides a computer program product adapted to perform a program of the following method operation when executed on a data processing device.

An information processing method applied to the control medium, including: receiving a first fingerprint feature file sent by a first terminal device, the first fingerprint feature file including at least fingerprint feature information of a user; sending a second fingerprint feature file to the server, the second fingerprint feature file including an identification of the user and the fingerprint feature information of the user to enable the server to save the second fingerprint feature file; sending a fingerprint feature information download request to the server, the fingerprint feature information download request including the identification of the user; receiving, by the server, fingerprint feature information corresponding to the identification of the user; sending the fingerprint feature information corresponding to the identification of the user to a target terminal device, the target terminal device being the first terminal device or a second terminal device.

Preferably, the receiving the first fingerprint feature file sent by the first terminal device includes: receiving, by the first terminal device, the first fingerprint feature file in a first ciphertext form.

Preferably, the first fingerprint feature file may further include the identification of the user. The sending the second fingerprint feature file to the server includes: sending an identification of the first terminal device and the first fingerprint feature file in the first ciphertext form to the server as the second fingerprint feature file. Alternatively, the identification of the user may be not included in the first fingerprint feature file. The sending the second fingerprint feature file to the server includes: sending the identification of the first terminal device, the acquired user identification, and the first fingerprint feature file in the first ciphertext form to the server as the second fingerprint feature file.

Preferably, the fingerprint feature information download request may further include an identification of the target terminal device.

The receiving the fingerprint feature information corresponding to the identification of the user sent by the server includes: receiving the fingerprint feature information in a third ciphertext form sent by the server. The fingerprint feature information in the third ciphertext form may be obtained by the server encrypting the fingerprint feature information corresponding to the identification of the user by using a private key corresponding to the identification of the target terminal device.

Preferably, the receiving the first fingerprint feature file sent by the first terminal device includes: receiving a plurality of data packets sent by the first terminal device. The plurality of data packets may be obtained by splitting the first fingerprint feature file.

Preferably, the first fingerprint feature file may further include first verification information of the user fingerprint feature information. Before saving the second fingerprint feature file, the server may perform a verification on the user fingerprint feature information based on the first verification information. If the verification is passed, the second fingerprint feature file may be saved.

Preferably, after sending the fingerprint feature information download request to the server, the method further includes: receiving a second verification information of the fingerprint feature information corresponding to the identification of the user sent by the server; sending the second verification information of the fingerprint feature information to the target terminal device. The target terminal device may perform a verification on the received fingerprint feature information using the second verification information after receiving the fingerprint feature information.

The technical solution for determining a control command processing status may be further described below. Although some embodiments in the present disclosure illustrate determining a control command processing status by taking an electronic lock as an example, it should be understood that the present disclosure is not limited to being applied to an electronic lock, but may also be applied to any other device, such as household appliances, etc.

FIG. 19 is a flowchart illustrating an exemplary process for controlling an electronic lock according to some embodiments of the present disclosure. As shown in FIG. 19, a method for controlling electronic lock may be executed by a server (e.g., the server 110 in FIG. 1). The server may communicate with the electronic lock.

In 1901, the server may obtain a request for controlling an electronic lock.

The control request for controlling the electronic lock may include a sending request, a freezing request, an unfreezing request, a valid period modification request or a deletion request, etc., sent by a user or an administrator to the electronic lock. Specifically, the control request for the electronic lock may be a processing request for password information such as a fingerprint, or may be any other control requests.

In 1902, the server may generate a control task for controlling the electronic lock. The control task may include at least one control command. The server may label a processing status of each control command as undone.

In the process for generating the control task for controlling the corresponding electronic lock according to the received control request, wherein the control task including at least one control command, the control command may be specifically an operation command for controlling the corresponding electronic lock, for example, freezing, unfreezing, modifying a period of validity of password information stored in the electronic lock, or deleting the password information. A processing status of the control command may be labeled as undone. The password information may include, for example, fingerprint information, iris information, facial information, etc.

In 1903, the server may send the at least one control command to the electronic lock.

In 1904, according to a result of each control command executed by the electronic lock, the processing status of each control command may be labeled as a corresponding preset label. The preset label may correspond to the execution result.

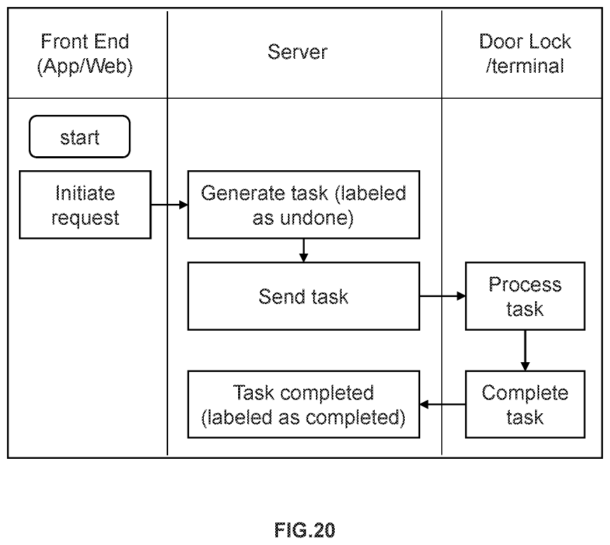

In the process that each control command is sent to the corresponding electronic lock, and the electronic lock performs corresponding operation processing according to the control command, when the result of each control command executed by the electronic lock is “done”, the processing status of each control command may be labeled as a corresponding preset label, and the preset label corresponds to the execution result. Specifically, the data flow of the overall technical solution is shown in FIG. 20.

FIG. 20 is a flowchart illustrating an exemplary process for controlling an electronic lock according to some embodiments of the present disclosure.

A control request in the embodiment of the present disclosure may be a control request for controlling password information and/or fingerprint information. Taking a fingerprint password electronic door lock as an example, the process for controlling the electronic lock may be as shown in FIG. 20.

Firstly, an operation request may be sent through a front terminal (e.g. an App or a web). The operation request may include a request for such as a sending operation, a freezing operation, an unfreezing operation, a valid period modification operation, a deletion operation, etc.

Secondly, a processing task may be generated by the server. Due to that a fingerprint cannot be synchronized to a target door lock immediately, a processing status of the corresponding fingerprint may be labeled as an intermediate status such as a status to be sent, to be frozen, to be unfrozen, to be modified, and to be deleted.

Thirdly, the fingerprint may be synchronized to the target door lock via a ZigBee network by the server, or the fingerprint may be synchronized to the target door lock via a Bluetooth network by a mobile phone.

Fourthly, the processing task may be processed in a polling manner until all the processing command(s) is/are completed. The intermediate undone status may be updated to be a done status (e.g., sent, frozen, unfrozen, modified, deleted, etc.), and the processing status of the fingerprint may be sent to the server.

By using the above mentioned technical solution, the problem of the intermediate status in fingerprint generation process due to the untimeliness of communication between the ZigBee network or Bluetooth network and the door lock may be solved.

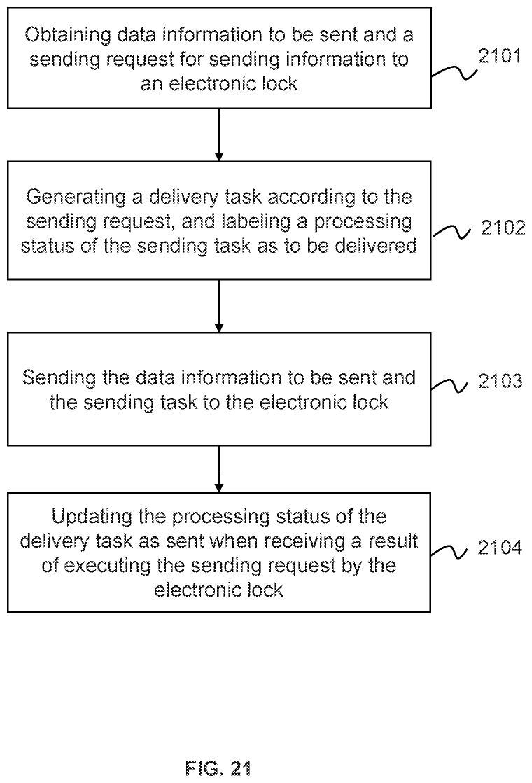

FIG. 21 is a flowchart illustrating an exemplary process of a control method when a request for the electronic lock is a sending request according to some embodiments of the present disclosure. Further, when the control request for the electronic lock is a sending request for the electronic lock, as shown in FIG. 3, the present disclosure provides a specific implementation of a control method of an electronic lock.

In 2101, data information to be sent and a sending request for sending information to an electronic lock may be obtained.

In 2102, a sending task may be generated according to the sending request, and a processing status of the sending task may be labeled as to be sent.

In 2103, data information to be sent and the sending task may be sent to the electronic lock.

In 2104, the processing status of the sending task may be updated as sent when receiving a result of executing the sending request by the electronic lock.

When sending the fingerprint, the process may include: initiating the sending request (a target fingerprint, a target door lock, and corresponding type of a fingerprint operation command (sending)) using an App/Web; receiving the sending request and generating a sending task, and labeling a processing status of the target fingerprint as to be sent by the server; parsing the sending task, and generating a sending command (sending the target fingerprint in the target lock); sending the sending command to the door lock via a ZigBee network by the server (sending the sending command to the target door lock to send the target fingerprint to the target door lock); processing the sending command, and notifying the server after completion by the door lock; updating the status to be sent as sent by the server (when it is determined that the sending task is completed, the processing status of the target fingerprint is labeled as sent).

When the request for controlling the electronic lock is a request for sending to the electronic lock, the data information to be send and the sending request for the electronic lock may be obtained first. Then, a sending task may be generated according to the sending request, and the processing status of the sending task may be labeled as to be sent. The data information to be send and the sending task may be sent to the electronic lock. The processing status of the sending task may be updated to be sent when receiving a result of executing the sending request by the electronic lock. The embodiment of the present disclosure labels the intermediate status of the issued request and feeds back the intermediate status of the issued request to a client so that a user can conveniently view the sending status of the electronic lock, which facilitates the user to quickly and quickly manage the electronic lock.

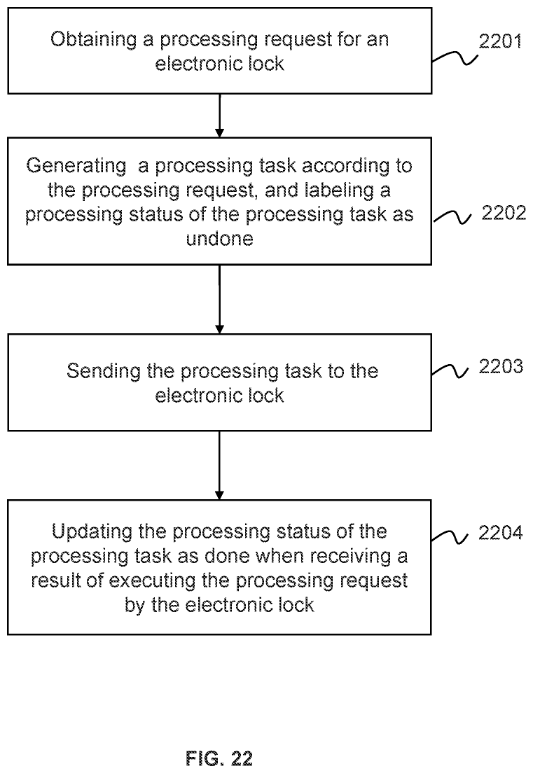

FIG. 22 is a flowchart illustrating an exemplary process of a control method when the request for controlling an electronic lock is a freezing request, an unfreezing request, a valid period modification request or a deletion request, according to some embodiments of the present disclosure.

Further, as shown in FIG. 4, when the control request for the electronic lock is a processing request for the electronic lock, and the processing request is a freezing request, an unfreezing request, a valid period modification request or a deletion request, the control method may be implemented as the following operations.

In 2201, a processing request for an electronic lock may be obtained.

In 2202, a processing task may be generated according to the processing request. A processing status of the processing task may be labeled as undone.

In 2203, the processing task may be sent to the electronic lock.

In 2204, the processing status of the processing task may be updated as done when receiving a result of executing the processing request by the electronic lock.

When the control request for the electronic lock is a freezing request, an unfreezing request, a valid period modification request or a deletion request, for the electronic lock, a freezing task, an unfreezing task, a valid period modification task, or a deletion task may be generated first according to the freezing request, the unfreezing request, the valid period modification request or the deletion request. The processing status of the task may be labeled as undone. The undone task may be sent to the electronic lock. When receiving a result of executing by the electronic lock for the freezing request, the unfreezing request, the valid period modification request or the deletion request, the freezing task, the unfreezing task, the valid period modification task, or the deletion task may be labeled as done. In embodiment of the present disclosure, an intermediate status of the freezing request, the unfreezing request, the valid period modification request or the deletion request may be labeled which may be feed back to a client terminal, so that the user can conveniently view the processing status of the electronic lock, which facilitates the user to quickly manage the electronic lock.

Preferably, when the control request for the electronic lock is a freezing request for freezing a target fingerprint in the electronic lock, the process may include: generating a freezing task according to the freezing request, and labeling a processing status of the target fingerprint as to be frozen; sending the freezing task to the electronic lock; modifying the processing status of the target fingerprint as frozen when receiving an execution result of the electronic lock for the freezing request.

When freezing the fingerprint, the process may include: initiating the freezing request (a target fingerprint, a target door lock, and corresponding type of a fingerprint operation command (freezing)) using an App/Web: receiving the freezing request and generating a freezing task, and labeling a processing status of the target fingerprint as to be frozen by the server; parsing the freezing task, and generating a freezing command (freezing the target fingerprint in the target lock); sending the freezing command to the door lock via a ZigBee network by the server (sending the freezing command to the target door lock to freeze the target fingerprint in the target door lock); processing the freezing command, and notifying the server after completion by the door lock; labeling the status to be frozen as frozen by the server (when it is determined that the freezing task is completed, the processing status of the target command is labeled as frozen).

Preferably, when the control request for the electronic lock is an unfreezing request for unfreezing a target fingerprint in the electronic lock, the process may include: generating an unfreezing task according to the unfreezing request, and labeling a processing status of the target fingerprint as to be unfrozen; sending the unfreezing task to the electronic lock; updating the processing status of the target fingerprint as unfrozen when receiving an execution result of the electronic lock for the unfreezing request.

When unfreezing the fingerprint, the process may include: initiating the unfreezing request (a target fingerprint, a target door lock, and corresponding type of a fingerprint operation command (unfreezing)) using an App/Web; receiving the unfreezing request and generating an unfreezing task, and labeling a processing status of the target fingerprint as to be unfrozen by the server; parsing the unfreezing task, and generating a unfreezing command (unfreezing the target fingerprint in the target lock); sending the unfreezing command to the door lock via a ZigBee network by the server (sending the unfreezing command to the target door lock to unfreeze the target fingerprint in the target door lock); processing the unfreezing command, and notifying the server after completion by the door lock; updating the status to be unfrozen as unfrozen by the server (when it is determined that the unfreezing task is completed, the processing status of the target command is labeled as unfrozen).

Preferably, when the control request for the electronic lock is a valid period modification request for modifying the valid period of a target fingerprint in the electronic lock, the process may include: generating a valid period modification task according to the valid period modification request, and labeling a processing status of the target fingerprint as to be modified; sending the valid period modification task to the electronic lock; updating the processing status of the target fingerprint as modified when receiving an execution result of the electronic lock for the valid period modification request.

When modifying the valid period of the fingerprint, the process may include: initiating the valid period modification request (a target fingerprint, a target door lock, and corresponding type of a fingerprint operation command (modifying the validity)) using an App/Web; receiving the valid period modification request and generating a valid period modification task, and labeling a processing status of the target fingerprint as to be modified by the server; parsing the valid period modification task, and generating a valid period modification command (modifying the validity of the target fingerprint in the target lock); sending the valid period modification command to the door lock via a ZigBee network by the server (sending the valid period modification command to the target door lock to modify the validity of the target fingerprint in the target door lock); processing the valid period modification command, and notifying the server after completion by the door lock; labeling the status to be modified as modified by the server (when it is determined that the valid period modification task is completed, the processing status of the target command is labeled as modified).

Preferably, when the control request for the electronic lock is a deletion request for deleting a target fingerprint in the electronic lock, the process may include: generating a deletion task according to the deletion request, and labeling a processing status of the target fingerprint as to be deleted; sending the deletion task to the electronic lock; modifying the processing status of the target fingerprint as deleted when receiving an execution result of the electronic lock for the deletion request.

When deleting the fingerprint, the process may include: initiating the deletion request (a target fingerprint, a target door lock, and corresponding type (deleting) of a fingerprint operation command) using an App/Web; receiving the deletion request and generating a deletion task, and labeling a processing status of the target fingerprint as to be deleted by the server; parsing the deletion task, and generating a deletion command (deleting the target fingerprint in the target lock); sending the deletion command to the door lock via a ZigBee network by the server (sending the deletion command to the target door lock to delete the target fingerprint in the target door lock); processing the deletion command, and notifying the server after completion by the door lock; updating the status to be deleted as deleted by the server (when it is determined that the deletion task is completed, the processing status of the target command is labeled as deleted).

The embodiments in the present disclosure may be used for a product such as a commercial fingerprint lock, and may have the following functions: when a tenant is checking in, the fingerprint input remotely may be labeled as to be sent, and may be labeled as sent after being sent; after the tenant or a co-tenant has checked in, the status of processing fingerprint remotely may be labeled. For example, the status of processing fingerprint remotely associated with freezing, unfreezing, and modifying the valid period may be labeled as to be frozen, to be unfrozen, and to be modified, and the fingerprint may be labeled as frozen, unfrozen, and modified when the operation on the fingerprint is completed; when the tenant cancels the lease, the fingerprint may be labeled as to be deleted, and the fingerprint may be labeled as deleted after being deleted.

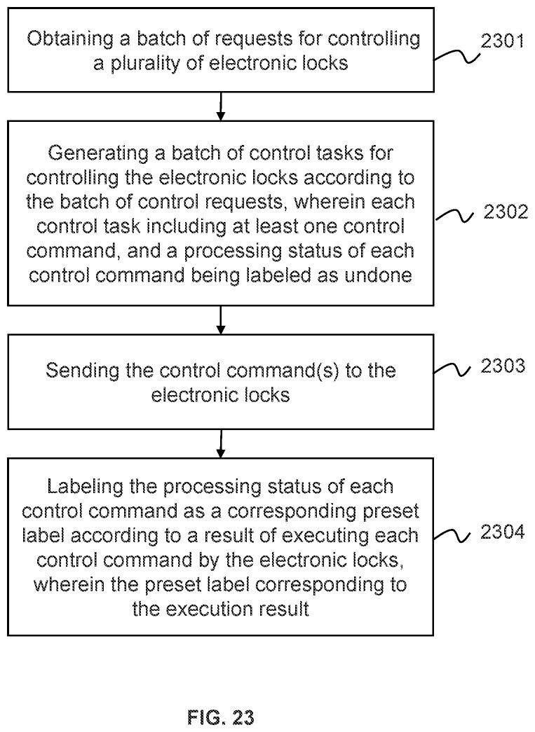

FIG. 23 is a flowchart illustrating an exemplary process of an electronic lock control method according to some embodiments of the present disclosure. As shown in FIG. 23, the present disclosure further discloses an electronic lock control method, which may be applied to the server. The server may communicate with a plurality of electronic locks.

In 2301, a batch of requests for controlling a plurality of electronic locks may be obtained.

The requests for controlling the plurality of electronic locks may include a sending request, a freezing request, an unfreezing request, a valid period modification request or a deletion request sent by a user or an administrator to the electronic locks.

Specifically, the requests for the electronic locks may be a request for processing password information such as a fingerprint, or may be a request for another control command.

In 2302, a batch of control tasks for controlling the electronic locks may be generated according to the requests. Each control task may include at least one control command. A processing status of each control command may be labeled as undone.

In the process for generating the batch of control tasks for controlling the plurality of electronic locks according to the received batch of requests, wherein each control task including at least one control command, the control command may be specifically an operation command for controlling the corresponding electronic lock, for example, freezing, unfreezing, modifying the valid period of password information stored in the electronic lock in the electronic lock or deleting the password information. A processing status of the control command may be labeled as undone. The password information may include information that can identify the password information such as fingerprint information, iris information, face information, etc.

In 2303, the at least one control command may be sent to the batch of electronic locks.

In 2304, according to a result of executing each control command by the electronic locks, the processing status of each control command may be labeled as a corresponding preset label. The preset label may correspond to the execution result.

In the process that each control command is sent to the corresponding electronic lock, and the electronic lock performs corresponding operation processing according to the control command, when the result of executing each control command by the electronic locks is completed, the processing status of each control command may be labeled as a corresponding preset label, and the preset label corresponds to the execution result.

The present disclosure discloses a method for controlling an electronic lock, including: obtaining a batch of requests for controlling a plurality of electronic locks; generating a batch of control tasks for controlling the electronic locks according to the requests, wherein each control task including at least one control command, and a processing status of each control command being labeled as undone; sending each control command to the electronic locks; labeling the processing status of each control command as a corresponding preset label according to a result of executing each control command by the electronic locks, wherein the preset label corresponding to the execution result. The present disclosure labels the intermediate status of the batch of control commands and feeds back the intermediate status of the batch of control commands to the client terminal, so that the user can conveniently view the control status of the electronic lock, which facilitates the user to quickly manage the electronic lock.

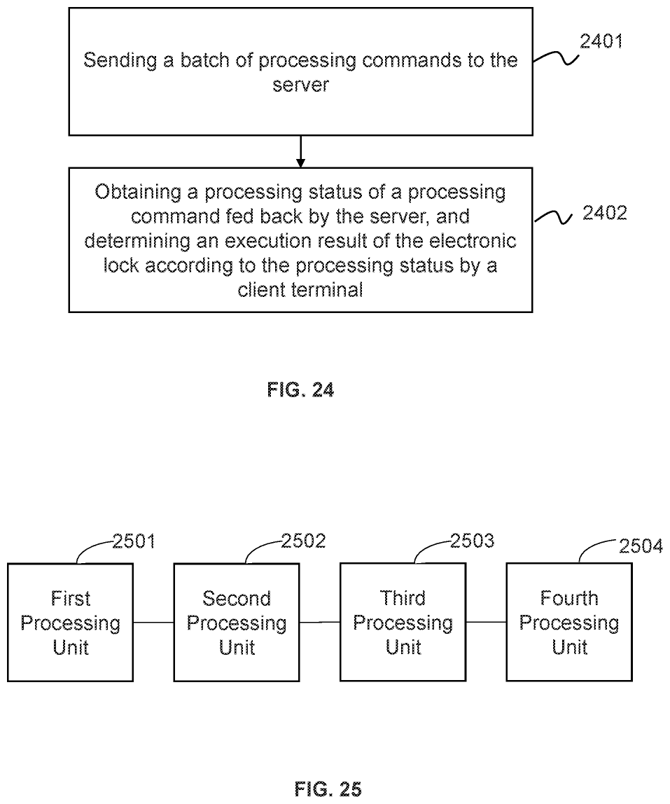

FIG. 24 is a flowchart illustrating an exemplary process of a method for controlling an electronic lock according to some embodiments of the present disclosure. According to above descriptions, as shown in FIG. 24, the present disclosure further discloses a method for controlling an electronic lock which is applied to a client terminal, and the client terminal may communicate with a server.

In 2401, a batch of processing commands may be sent to the server.

The client terminal may send a batch of processing commands to the server. The batch of processing commands may correspond to at least one electronic lock. That is, the batch of processing commands may correspond to one electronic lock, or a plurality of electronic locks.

In 2402, a processing status of a processing command fed back by the server may be obtained. The client terminal may determine an execution result of the electronic lock according to the processing status.

The client terminal may receive the processing status of the electronic lock fed back by the server in real-time, and determine the execution result of the electronic lock according to the received processing status, and retrieve the status of the electronic lock in real-time.

The present disclosure discloses a method for controlling an electronic lock, the method is applied to the server, and the server is communicatively connected with the electronic lock, and the method may include: obtaining a request for controlling the electronic lock; generating a control task for controlling the electronic lock according to the control request, and the control task including at least one control command, and a processing status of each control command being labeled as undone; sending each control command to the electronic locks; labeling the processing status of each control command as a corresponding preset label according to a result of executing each control command by the electronic locks, the preset label corresponding to the execution result. In the embodiment of the present disclosure an intermediate status of the control command may be labeled which may be feedback to a client terminal, so that the user can conveniently view the processing status of the electronic lock, which facilitates the user to quickly manage the electronic lock.

For each of the foregoing embodiments, for the sake of simple description, they are all expressed as a series of action combinations. However, it will be appreciated by those skilled in the art that the present disclosure is not limited by the order of the acts described, as some operations may be performed in other sequences or concurrently in accordance with the present disclosure. In the following, those skilled in the art should also understand that the embodiments described in the present disclosure are intended to be preferred embodiments, and the acts and modules involved are not necessarily required by the present disclosure.

FIG. 25 is a schematic diagram illustrating an exemplary electronic lock control device according to some embodiments of the present disclosure. The method is described in detail in the disclosed embodiments of the present disclosure, and the method of the present disclosure may be implemented in a variety of forms, thus the present disclosure also discloses a device, which is described in detail below with reference to specific embodiments.

As shown in FIG. 25, an electronic lock control device may be disclosed in the present disclosure, and the control device may include a first processing unit 2501, a second processing unit 2502, a third processing unit 2503, and a fourth processing unit 2504.

The first processing unit 2501 may be configured to obtain a request for controlling an electronic lock.

The second processing unit 2502 may be configured to generate a control task for controlling the electronic lock according to the request. The control task may include at least one control command, and a processing status of each control command may be labeled as “undone”.

The third processing unit 2503 may be configured to send each control command to the electronic lock.

The fourth processing unit 2504 may be configured to label the processing status of each control command as a corresponding preset label according to a result of executing each control command by the electronic lock. The preset label may correspond to the execution result.

Further, when the control request for the electronic lock is a sending request, the device may include modules as described below.

The first processing unit 2501 may be configured to obtain data information to be sent and a sending request for an electronic lock.

The second processing unit 2502 may be configured to generate a sending task according to the sending request, and label a processing status of the sending task as to be sent.

The third processing unit 2503 may be configured to send the data information to be sent and send the sending task to the electronic lock.

The fourth processing unit 2504 may be configured to modify the processing status of the sending task as sent when a result of executing the sending request by the electronic lock is received.

Further, when the control request for the electronic lock is a processing request for the electronic lock, the processing request is a freezing request, an unfreezing request, a valid period modification request, or a deletion request, the device may include units as described below.

The first processing unit 2501 may be configured to obtain a processing request for an electronic lock.

The second processing unit 2502 may be configured to generate a processing task according to the processing request and label a processing status of the processing task as undone.

The third processing unit 2503 may be configured to send the processing task to the electronic lock.

The fourth processing unit 2504 may be configured to update the processing status of the processing task as done when a result of executing the processing request by the electronic lock is received.

The present disclosure discloses an electronic lock control device, firstly the first processing unit obtains a request for controlling an electronic lock; secondly, the second processing unit generates a control task for controlling the electronic lock according to the request, the control task including at least one control command, and the processing status of each control command being labeled as undone; then the third processing unit sends each control command to the electronic lock; finally, the fourth processing unit labels the processing status of each control command as a corresponding preset label according to a result of executing each control command by the electronic lock, and the preset label may correspond to the execution result. In the embodiment of the present disclosure, an intermediate status of the control command may be labeled which may be feedback to a client terminal, so that the user can conveniently view the processing status of the electronic lock, which facilitates the user to quickly manage the electronic lock.

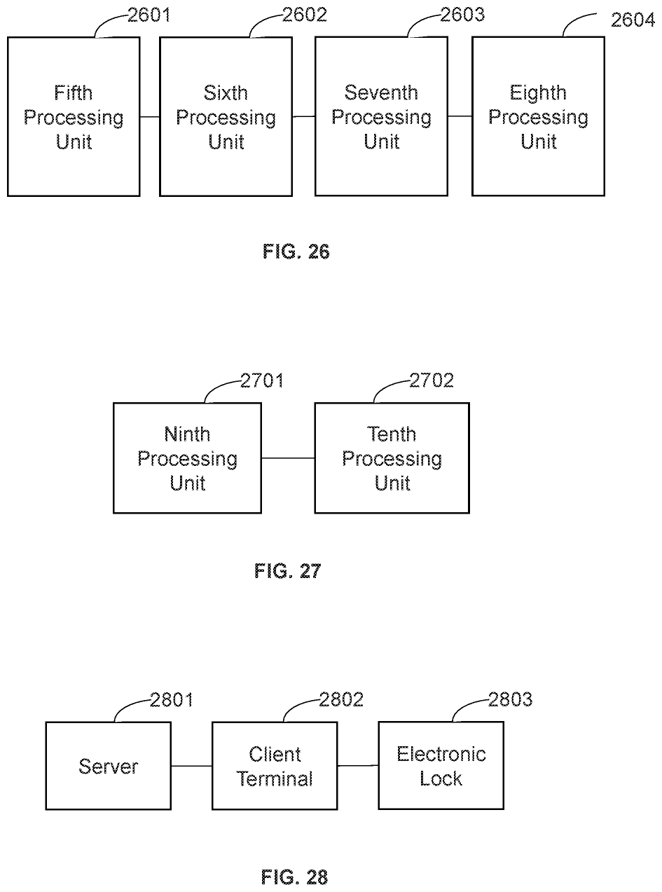

FIG. 26 is a schematic diagram illustrating an exemplary electronic lock control device according to some embodiments of the present disclosure. As shown in FIG. 26, an electronic lock control device may be disclosed in the present disclosure, and the control device may include a fifth processing unit 2601, a sixth processing unit 2602, a seventh processing unit 2603, and an eighth processing unit 2604.

The fifth processing unit 2601 may be configured to obtain a batch of requests for controlling a plurality of electronic locks.

The sixth processing unit 2602 may be configured to generate a batch of control tasks for controlling the electronic locks according to the batch of requests. Each control task may include at least one control command. A processing status of each control command may be labeled as undone.

The seventh processing unit 2603 may be configured to send the control command(s) to the electronic locks.

The eighth processing unit 2604 may be configured to label the processing status of each control command as a corresponding preset label, according to a result of executing the control command by a corresponding electronic lock. The preset label may correspond to the execution result.

The present disclosure discloses an electronic lock control device, firstly the fifth processing unit obtains a batch of requests for controlling a plurality of electronic locks; secondly, the sixth processing unit generates a batch of control tasks for controlling the electronic locks according to the batch of requests, each control task including at least one control command, and a processing status of each control command is labeled as undone; then the seventh processing unit sends the control command(s) to the electronic locks; finally, the eighth processing unit labels the processing status of each control command as a corresponding preset label according to a result of executing each control command by a corresponding electronic lock, and the preset label corresponds to the execution result. In the embodiment of the present disclosure an intermediate status of the control command may be labeled which may be feedback to a client terminal, so that the user can conveniently view the processing status of the electronic lock, which facilitates the user to quickly manage the electronic lock.

FIG. 27 is a schematic diagram illustrating an exemplary electronic lock control device according to some embodiments of the present disclosure. As shown in FIG. 27, an electronic lock control device may be disclosed in the present disclosure, and the control device may specifically include a ninth processing unit 2701 and a tenth processing unit 2702.

The ninth processing unit 2701 may be configured to send a batch of processing commands to the server.

The tenth processing unit 2702 may be configured to obtain a processing status of each of the batch of processing commands fed back by the server, and the client terminal may determine an execution result of the electronic lock according to the processing status.

FIG. 28 is a schematic diagram illustrating an exemplary electronic lock control system according to some embodiments of the present disclosure. As shown in FIG. 28, an electronic lock control system may be disclosed in the present disclosure, and the control system may specifically include a server 2801, a client terminal 2802, and an electronic lock 2803. The client terminal 2802 may be communicate with the server 2801, and the server 2801 may communicate with the electronic lock 2803.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Per, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A system, comprising:
at least one storage medium storing a set of instructions;
at least one processor in communication with the at least one storage medium, wherein when executing the set of instructions, the at least one processor is directed to cause the system to:
obtain a feature file of a user, the feature file of the user including feature information of the user; the feature information of the user being generated by a first terminal device;
store the feature file of the user;
receive a first request for obtaining the feature information of the user; and
send, in response to the first request, the feature information of the user to a target device.

2. The system of claim 1, wherein:
the feature file of the user is encrypted with a first key corresponding to the first terminal device;
to store the feature file of the user, the at least one processor is further directed to cause the system to:
acquire the first key corresponding to the first terminal device;
decrypt, using the first key, the feature file of the user encrypted with the first key to obtain a decrypted feature file of the user; and
store the decrypted feature file of the user.

3. The system of claim 2, wherein to store the decrypted feature file of the user, the at least one processor is further directed to cause the system to:
verify the decrypted feature file of the user; and
in response to passing the verification, store the decrypted feature file of the user.

4. The system of claim 2, wherein to store the decrypted feature file of the user, the at least one processor is further directed to cause the system to:
encrypt the decrypted feature file of the user with a second key corresponding to the system to obtain a feature file of the user encrypted with the second key; and
store the feature file of the user encrypted with the second key.

5. The system of claim 1, wherein:
the feature information of the user is encrypted with a first key corresponding to the first terminal device;
the feature file of the user further includes an identification of the user;
to store the feature file of the user, the at least one processor is further directed to cause the system to:
acquire the first key corresponding to the first terminal device;
decrypt, using the first key, the feature information of the user encrypted with the first key to obtain a decrypted feature file of the user including decrypted feature information of the user and the identification of the user; and
store the decrypted feature file of the user.

6. The system of claim 5, wherein to store the feature file of the user, the at least one processor is further directed to cause the system to:
verify the decrypted feature information;
in response to passing the verification, store the decrypted feature file of the user.

7. The system of claim 5, wherein to store the feature file of the user, the at least one processor is further directed to cause the system to:
encrypt, using a second key corresponding to the system, the decrypted feature file of the user to obtain a feature file of the user encrypted with the second key; and
store the feature file of the user encrypted with the second key.

8. The system of claim 5, wherein:
the first request includes an identification of the target device and an identification of the user;
to send, in response to the first request, the feature information of the user to a target device, the at least one processor is further directed to cause the system to:
retrieve, based on the identification of the user, the feature information of the user from feature information of a plurality of users;
acquire, based on the identification of the target device, a third key corresponding to the target device;
encrypt the feature information of the user with the third key; and
send the feature information encrypted with the third key to the target device.

9. The system of claim 1, wherein:
the system is a server;
to obtain a feature file of a user, the at least one processor is directed to cause the system to:
obtain the feature file of a user from a control medium;
the feature information of the user is sent to the control medium by the first terminal device; and
to send, in response to the first request, the feature information of the user to a target device, the at least one processor is directed to cause the system to:
send, in response to the first request, the feature information of the user to the control medium so as to enable the control medium to send the feature information of the user to the target device.

10. The system of claim 1, wherein the at least one processor is further directed to cause the system to:
receive a second request for controlling the target device;
generate a control command in response to the second request;
assign the control command a preliminary status;
send the control command to the target device to control the target device;
receive a result of the target device performing the control command; and
update, based on the result, the preliminary status of the control command.

11. A system, comprising:
at least one storage medium storing a set of instructions;
at least one processor in communication with the at least one storage medium, wherein when executing the set of instructions, the at least one processor is directed to cause the system to:
receive a first feature file of a user from a first terminal device, the first feature file of the user including feature information of the user;
send a second feature file of the user to a server, so as to enable the server to store the second feature file of the user, the second feature file of the user including the feature information of the user;
send a request for obtaining the feature information of the user to the server;
receive the feature information of the user sent by the server in response to the request; and
send the feature information of the user received from the server to a target device.

12. The system of claim 11, wherein to receive a first feature file of a user from a first terminal device, the at least one processor is directed to cause the system to:
receive the first feature file of the user encrypted with a first key.

13. The system of claim 12, wherein:
the first feature file of the user further includes an identification of the user;
the second feature file of the user includes an identification of the first terminal device and the first feature file of the user encrypted with the first key;
or
the first feature file of the user does not include an identification of the user;
the at least one processor is further directed to cause the system to:
obtain an identification of the user;
the second feature file of the user includes an identification of the first terminal device, the identification of the user, and the first feature file of the user encrypted with the first key.

14. The system of claim 11, wherein:
the request for obtaining the feature information of the user includes an identification of the target device;
to receive the feature information of the user sent by the server in response to the request, the at least one processor is directed to cause the system to:
receive the feature information of the user encrypted with a second key sent by the server; the feature information of the user encrypted with the second key being generated by the server encrypting, using the second key corresponding to an identification of the target terminal, the feature information of the user.

15. The system of claim 11, wherein to receive a first feature file of a user from a first terminal device, the at least one processor is directed to cause the system to:
receive at least one data packet from the first terminal device, the at least one data packet being generated by the first terminal device splitting the first feature file of the user.

16. The system of claim 11, wherein the first feature file of the user further includes first verification information corresponding to the feature information of the user, so as to enable the server to verify, based on the first verification information, the user feature information, and store the second feature file of the user in response to passing the verification.

17. The system of claim 11, wherein the at least one processor is further directed to cause the system to:
receive second verification information corresponding the feature information of the user from the server;
send the second verification information to the target device, so as to enable the target device to verify, based on the second verification information, the received feature information of the user.

18. A system, comprising:
at least one storage medium storing a set of instructions;
at least one processor in communication with the at least one storage medium, wherein when executing the set of instructions, the at least one processor is directed to cause the system to:
receive a request for controlling a target device;
generate, based on the request, a control task for controlling the target device, the control task including at least one control command;
assign the control task a preliminary status;
send the at least one control command to the target device to control the target device;
receive a result of the target device performing the at least one control command; and
update, based on the result, the preliminary status of the control task.

19. The system of claim 18, wherein the request for controlling the target device is a request for sending data to the target device, the at least one processor is further directed to cause the system to:
acquire data to be sent;
generate, based on the request, a sending task, the sending task including at least one sending command;
assign the sending task a status as to be sent;
send the data to be sent and the at least one sending command to the target device;
receive a result of the target device performing the at least one sending command; and
update, based on the result, the status of the sending task as sent.

20. The system of claim 18, wherein the request for controlling the target device is a request for processing data in the target device, the at least one processor is further directed to cause the system to:
generate, based on the request, a processing task, the processing task including at least one processing command;
assign the processing task a status as undone;
send the at least one processing command to the target device;
receive a result of the target device performing the at least one processing command; and
update, based on the result, the status of the processing task as done.
